(19) United States
(12) Patent Application Publication
(10) Pub. No.: US 2024/0078769 A1
(43) Pub. Date: Mar. 7, 2024

(54) SYSTEMS AND METHODS FOR A POLICY-GOVERNED CONTENT MEDIATION MODEL FOR MOBILE AUGMENTED REALITY APPLICATIONS

(71) Applicant: Arizona Board of Regents on Behalf of Arizona State University, Tempe, AZ (US)

(72) Inventors: Carlos Rubio-Medrano, Corpus Christi, TX (US); Luis Claramunt, Gilbert, AZ (US); Jaejong Baek, Chandler, AZ (US); Gail-Joon Ahn, Chandler, AZ (US)

(21) Appl. No.: 18/461,421

(22) Filed: Sep. 5, 2023

Related U.S. Application Data
(60) Provisional application No. 63/374,493, filed on Sep. 2, 2022.

(51) Int. Cl. G06T 19/00; H04L 67/131; H04L 67/52

(52) U.S. Cl. CPC G06T 19/006; H04L 67/131; H04L 67/52

(57) ABSTRACT

A system implements a Policy-Governed Content Mediation Model for Mobile Augmented Reality (MAR) applications (MAR-Apps) by regulating the real-time interaction between digital MAR content, e.g., 3D objects displayed on top of a video stream, and the actual physical world. The system regulates the way MAR content is distributed inside physical spaces by means of the specification, evaluation, and enforcement of user-friendly authorization policies based on security-relevant information, a.k.a., attributes, ultimately resulting in the avoidance of unwanted content distribution and/or unwanted user interactions. Consequently, the system protects sensitive spaces as only authorized MAR content is authorized to merge with the physical surroundings. Additionally, the system allows benign multi-user interactions and respects the users' privacy by granting and enforcing management over user-supplied sensitive information.

### CROSS-REFERENCE TO RELATED APPLICATIONS

This is a U.S. Non-Provisional Patent Application that claims benefit to U.S. Provisional Patent Application Ser. No. 63/374,493 filed 2 Sep. 2022, which is herein incorporated by reference in its entirety.

### GOVERNMENT SUPPORT

This invention was made with government support under awarded by the National Science Foundation. The government has certain rights in the invention.

### FIELD

The present disclosure generally relates to content mediation in mobile applications, and in particular, to a system and associated method for enforcing authorization constraints and preventing spatial and privacy attacks in mobile augmented reality applications.

### BACKGROUND

Mobile Augmented Reality (MAR) is a portable implementation of Augmented Reality (AR), that enables real-time interaction between digital content, e.g., 3 dimensional (3D) objects and audio files, and the actual physical world. Recently, it has been implemented in Mobile Applications (MAR-Apps) accessible through smartphones, tablets, etc. Its popularity has considerably grown as it tends to enrich users' experience and improve satisfaction for shopping, entertainment, productivity, and gaming.

However, even as millions of people already use MAR-Apps, there is an absence of regulation over how they operate. For example, there is no limitation over where MAR-Apps can be launched as well as an absence of restrictions over the MAR content available and distributed to and among users. Thus, the unregulated distribution of inappropriate and malicious AR content has the potential to cause dangerous or undesired actions.

It is with these observations in mind, among others, that various aspects of the present disclosure were conceived and developed.

### BRIEF DESCRIPTION OF THE DRAWINGS

FIG. 1 is a diagram showing a threat model for MAR-Apps for illustration of various problems to be solved by a system outlined herein;

FIG. 2 is a simplified block diagram showing a system for MAR-App management in accordance with the present disclosure;

FIGS. 3A-3C are a series of block diagram showing operation of the system of FIG. 2 for enforcing policies regulating content, users and services associated with an MAR-App;

FIGS. 4A and 4B illustrate one embodiment of a proof-of-concept MAR-App that includes aspects of the system of FIG. 2;

FIG. 5A illustrates entities and functionalities of a model for policy-governed MAR-Apps with respect to the system of FIG. 2 and the proof-of-concept MAR-App of FIGS. 4A and 4B;

FIG. 5B illustrates aspects of a Space-Sensitive Access Control (SSAC) implementation of the system of FIG. 2;

FIGS. 6A and 6B are a pair of screenshots showing example user interfaces for creating policies using the proof-of-concept MAR-App of FIGS. 4A and 4B, where FIG. 6A shows a geographical boundary area and where FIG. 6B shows defining a constraint to be enforced within the geographical boundary area;

FIG. 7 is a tree diagram showing examples of “open” policies regulating MAR content and access using the proof-of-concept MAR-App of FIGS. 4A and 4B;

FIGS. 8A and 8B are a pair of screenshots showing example user interfaces of a first room (FIG. 8A) and a second room (FIG. 8B) using the proof-of-concept MAR-App of FIGS. 4A and 4B;

FIG. 9 is a diagram showing user interaction within rooms as implemented by the system of FIG. 2;

FIG. 10 is a screenshot showing an attribute wallet of the system of FIG. 2;

FIGS. 11A and 11B are a pair of screenshots showing a policy for a sensitive space and a policy for user interaction that were provided within a questionnaire for validation of the system of FIG. 2;

FIG. 12 is a graphical representation showing comprehension scores for security issues by subjects during validation of the system of FIG. 2;

FIG. 13 is a graphical representation showing detection of security issues by subjects during validation of the system of FIG. 2;

FIG. 14 is a graphical representation showing performance in user-based policy writing by subjects during validation of the system of FIG. 2;

FIG. 15 is a graphical representation showing perceived privacy performance of the system of FIG. 2; and

FIG. 16 is a simplified diagram showing an example computing device implementation of the system of FIG. 2.

Corresponding reference characters indicate corresponding elements among the view of the drawings. The headings used in the figures do not limit the scope of the claims.

### DETAILED DESCRIPTION

### 1. Introduction

Augmented Reality (AR) alters the perception of the physical world by merging natural objects with additional digital content, e.g., 3D virtual objects, resulting in distinct users' sights of their surroundings. Noticeably, its popularity has increased recently with the introduction of Mobile Augmented Reality (MAR), which leverages mobile devices with low accessibility costs, high power, and communication infrastructure. Currently, several types of applications implement MAR, hereby referred to as MAR-Apps. For example, there are MAR-Apps used for shopping (e.g., IKEA Place, Wayfair, eBay, etc.), entertainment (e.g., Snapchat, MARK, etc.), productivity (e.g., GeoGebra, Measure, etc.), and gaming (e.g., Jurassic World Live, etc.). Furthermore, the last category involves one of the most successful MAR-Apps: Pokemon GO, which became a worldwide phenomenon since its release in 2016 when it experienced 21 million daily active users. Despite being still in its early development stages, MAR has succeeded in value, as users and implementation raised considerably. Likewise, further development on libraries facilitates MAR execution, e.g., ARCore, ARKite, Vuforia, etc. Therefore, it is no surprise that Allied Market Research anticipates the MAR market to reach $184.61 billion by 2030, from $12.61 billion in 2020, with a compound annual growth rate of 31.40% from 2021 to 2030.

Thus, with such tremendous potential and with no standard over how to regulate MAR-Apps, it is crucial to consider their safety as some, i.e., Pokemon GO, have been problematic, depicting three major security issues; based on recorded incidents and possible outbreaks. First, Space Owners, the entities who are in charge of sensitive spaces, e.g., memorials, hospitals, etc. must have the opportunity to regulate MAR-Apps operations within such locations, as some MAR content might be unwanted or lead to unwelcome behavior; otherwise, they would suffer from Space Invasion. Such incident has already occurred throughout the world with Pokemon GO as Space Owners dealt with intrusive MAR, e.g., the 9/11 Memorial in New York City, Auschwitz, etc. Second, there is also a possibility for digital graffiti as MAR leaves physically unnoticeable traces, e.g., stickers, drawings, messages, 3D objects, etc. Currently, there are no restrictions on such content, allowing hostile entities to place malicious content easily. Furthermore, such entities have already exploited MAR-Apps compromising users' security to execute robberies, fights, assaults, etc. Overall, the MAR content experience of users is deprecated via dangerous content and risky multi-user interactions, which lead to Space Affectation issues. Third, MAR-Apps also deal with sensitive information, which leads to Privacy Leak if gathered without explicit user consent or is unwillingly shared with third parties. This issue, which has been found to occur in other sorts of mobile apps, also occurs when MAR-Apps mishandle sensitive information, e.g., device facts, user location, user data, etc.

To alleviate these concerns, the present disclosure outlines an approach for regulating the operations of MAR-Apps, e.g., under what circumstances they can display 3D objects on certain physical spaces, by means of user-issued authorization policies. For example, Space Owners may be allowed to adequately restrain the utilization of MAR-Apps within their domains, thus preventing the Space Invasion attack described above. Similarly, the interaction between users of MAR-Apps can be also controlled through Rooms: isolated and regulated MAR environments for users to join in which the distribution of MAR content can be regulated. This way, each Room receives unique MAR objects, as well as policies created by users determining regulations for access and acceptable MAR content, thus potentially preventing the Space Affectation attack. Alongside, users are also allowed to know and control the release of all the sensitive information collected from them by MAR-Apps through an Attribute Wallet: an abstract container which handles the data gathering and release by means of user-issued authorization policies, thus also resulting in the prevention of the Privacy Leak attack. Overall, the specification, evaluation, and enforcement of such security-related constraints lead to development of a Policy-Governed MAR-App that enables a Space Owner to control the use of MAR-Apps within their domain. The present disclosure demonstrates such a concept by means of SpaceMediator, a proof-of-concept Policy-Governed MAR-App that imitates the popular Pokemon GO, as it represents a multiplayer geolocation-based scheme where multi-user interaction is possible through assigned locations to available MAR objects. Although, it respects protected sensitive spaces, restrains interaction among users, and allows them to manage gathered sensitive information.

In order to evaluate the effectiveness and the usability of the present approach, a user study was conducted with 40 participants. Without a requirement of prior computer science knowledge or exposure to MAR, they were introduced to the security issues found in MAR-Apps, prevented them in SpaceMediator, and provided feedback reflecting their experience. Exemplary research questions considered in the user study included the following:
RQ1 Can participants understand the concepts of space invasion, space affectation, and privacy leak attacks?
RQ3 Can participants write effective Space Protection Policies?
RQ4 Can participants write effective User Interaction Policies?
RQ7 Do participants agree with the regulation of MAR-Apps?

The results were satisfactory as, for example, participants comprehended the attacks with rankings as high as 4.65 on a scale from 1 to 5; also, 87.50% of them agreed on Policy-Governed MAR-Apps over sensitive spaces, and 82.50% would implement user regulations. Likewise, they wrote policies to regulate the operations of Space-Mediator, which assisted us in testing the feasibility of leaving the regulation responsibilities to ordinary users.

Overall, the present disclosure provides the following contributions:
Discussion of in practice occurrence of the Spatial Invasion, Spatial Affectation, and Privacy Leak attacks in a series of MAR-Apps collected from Google Play.
SpaceMediator, an Open-Source Policy-Governed MAR-App that alleviates the aforementioned attacks by giving Space Owners and Users full control over their interaction with MAR content.
Results of a user study featuring SpaceMediator, which shows that Policy-Governed MAR-Apps can be understood and practiced by users with a high degree of efficiency and overall satisfability.

### 2. Background and Related Work

2.1 Mobile Augmented Reality

Mobile Augmented Reality (MAR) is a portable implementation of Augmented Reality (AR) that enables real-time interaction between 3D digital content and the actual physical world. It is commonly implemented in mobile applications, thereby referred to as MAR-Apps, accessible through hand-held devices such as smartphones and tablets. The popularity of MAR has considerably grown as it tends to enrich users' experience and improve satisfaction. MAR-Apps have diverse categories, e.g., games, shopping, entertainment, productivity, education, etc. Also, there are some geolocation-based MAR-Apps in which MAR objects are displayed depending on the user's location. For example, Live View Google Maps provides directions with AR arrows which are consistently updated to guide the user to navigate the surroundings. Another example is the very successful MAR-App Pokemon GO, in which users must reach the precise spot assigned to a Pokemon to capture it by touching the screen to throw a Poke Ball.

Furthermore, as the requirement for MAR is for AR technology to be portable, it is worth pointing out that MAR is not limited to handheld devices, as highly-specialized supporting hardware, e.g., AR headsets and AR smart-glasses, are reportedly under development and are expected to be released to the public in the next few years. Generally, as these novel devices are expected to be wearable, they may lead to more extended utilization with constant modification of surroundings through virtual content. However, as of today, the high-quality AR output they tend to offer brings affordability issues. As such, the present disclosure focuses on regulating the operations of MAR-Apps on hand-held devices as they are the major trend in MAR utilization and are also more accessible since no extra gear is required. This approach can be also extended to specialized AR hardware in the future.

2.2 Incidents Involving MAR

Currently, there is an absence of regulations regarding how MAR-Apps should operate. For example, there are no restrictions over where MAR-Apps can be launched, no restrictions over the MAR content available to users, and no restrictions on how MAR objects are distributed among users. As a result, as the popularity of MAR-Apps increases, more incidents caused by MAR have been recorded. For example, people have been able to play Pokemon GO at the 9/11 Memorial in New York City, which was viewed as disrespectful by many within the community. Similar situations occurred in Poland's Auschwitz Memorial and Washington's D.C. Holocaust Museum, which requested MAR-Apps to be unplayable sites. The regulation deficiency over how MAR objects are distributed has also compromised users, as it is common for everyone in a MAR-App to have access to the same MAR objects. This has raised security and safety issues as malicious users waited at places where interactive MAR objects were available to assault or rob other users. Moreover, the lack of regulations has also caused crowds of hundreds of players leading to unpleasant noisy environments. Finally, MAR-Apps users have also been involved in general incidents. For example, users broke into private properties as they did not respect the boundaries of deployed MAR objects, had car accidents as they used MAR-Apps while driving, or were injured because of distracted behavior while utilizing MAR-Apps.

2.3 Related Work

One research group recognized security risks in virtual content. Although they utilized virtual reality, i.e., HoloLens, the present disclosure focuses on accessible MAR-Apps, both technologies output virtual content that merges with the physical world and alters users' perspective. Furthermore, virtual content genuinely impacts the physical world, affecting users' actions and behaviors. Thus, maliciously placed AR content might cause dangerous or undesired actions among users. Alongside, a threat was detected in multi-user AR, especially among co-located users who modified each other via available AR, e.g., drawing, placing AR objects, etc. Similarly, users were concerned about inappropriate or hostile AR content. As a result, the necessity for further AR regulation was acknowledged, along with challenges in its multi-user implementation: users shall manage their personal space, interact with AR objects personally, and control access to them, resulting in avoidance of unwanted interchange with others.

Another work identified security risks involved in MAR-Apps' abilities to modify users' surroundings, as malicious MAR-Apps were identified as capable of causing incidents by obscuring the real world. As a result, to prevent such happenings, MAR-Apps constraint their visual content through policies, which modify MAR content through specified attributes (e.g., size, rotation, etc.). However, while such policies restructured the output, they did not include regulations that limited available MAR content.

Some AR content may be considered safety-critical as risks over incorrect AR output may lead to dangerous side effects (e.g., driving, medicine, airplane maintenance, etc.). Therefore, research to analyze and prevent threats over such AR output has been conducted. However, this safety-critical AR is less accessible than MAR-Apps because it requires more expensive tools. Nonetheless, it is agreed that AR output impacts users as they perceive the AR content, meaning varies, along with decisions taken afterward. Thus, mitigation of risky AR implies avoiding particular AR objects and reducing dangerous usage consequences, i.e., limiting usage time.

Finally, privacy issues over AR are also a primary concern as several researchers have assessed it. For example, one work developed a successful tracking system to follow users' location in multi-user geolocation-based MAR-Apps. Alongside, the systems outlined in the present disclosure allow users to manage data gathered from them, as discussed further in § 4.4 herein.

### 3. Problem Statement

As MAR offers a wide variety of services, it is possible to find distinct types of vulnerabilities throughout MAR-Apps. Therefore, it is essential to specify which ones are prioritized throughout this paper. This section starts with a discussion on a threat model in § 3.1, and continues with a description of the Space Invasion, the Space Affectation, and the Privacy Leak attacks in § 3.2.

3.1 Threat Model

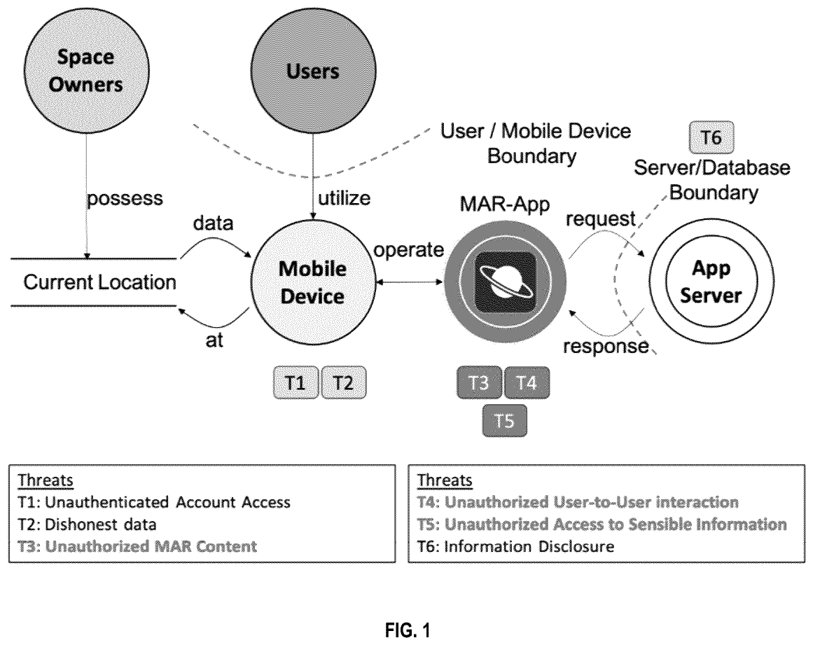

FIG. 1 provides a graphical depiction of a Threat Model featuring the security implications for a MAR-App implemented with a cloud service. MAR-Apps communicate with cloud services and provide comparative data, e.g., location, username, etc., to supplement available MAR content to users. Communication frequency and available content vary according to each MAR-App. Generally, MAR content is available 24/7 and saved for future use. Typical uses include capturing MAR objects, leaving MAR object traces in defined spaces, etc. Some of the denoted threats are ways attackers could exploit mobile apps in general, i.e., stealing poorly stored login credentials (T1), modifying data provided by cellular devices to apps (T2), and intercepting insecurely exchanged information (T6). The present disclosure focuses mostly on threats applicable to unregulated MAR-Apps with possible malicious MAR content (T3), leading to dangerous interaction (T4), and with forbidden access to sensitive data (T5). As shown in § 3.3 and Table 1, several MAR-Apps currently available in practice were analyzed and found to be vulnerable to at least one of these threats.

3.2 Spatial and Privacy Attacks

Space Invasion Attack. This attack results from the successful exploitation of T3, and occurs when the Space Owner, the entity responsible for sensitive spaces, is unsatisfied with the MAR-Apps that can be executed within the location. There are two possible ways MAR-Apps negatively affect sensitive spaces. First, unwanted MAR content that merges with the physical world conducts negative interaction and virtual editing of its surroundings, as described in § 2.1. Second, geolocation-based MAR-Apps could lead users to sensitive spaces and stimulate undesired behaviors, e.g., conglomerations, noisy environments, etc. As a result, space invasion attacks are triggered by unwanted MAR content or subjects that come around to interact with it, as mentioned in the real-world scenarios featured in § 2.2.

Space Affectation Attack. This attack results from the successful exploitation of T4, and is a result of meanly degraded MAR-Apps users' experience, triggered by intrusive MAR content, through which users must interact with MAR objects they despise, and negative user-to-user interaction. Geolocation-based MAR-Apps may lead towards user-to-user interaction as two players meet at the exact spot assigned to a MAR object to play with it. Unfortunately, malicious users have taken advantage of such scenarios, and the multiplayer concept implemented throughout certain MAR-Apps has led to robberies, armed assaults, and other situations.

Privacy Leak Attack. This attack results from the successful exploitation of T5. There have been several mobile applications with recorded privacy incidents. Even when privacy issues are not restricted to MAR-Apps, it is noticeable that MAR-Apps share sensitive information between users and even without their explicit consent resulting in Privacy Leak. There is no specific range over the collected data as it could be distributed, i.e., location.

3.3 An Exploratory Study on Vulnerable MAR-Apps in Practice

In order to establish the potential occurrence of the aforementioned attacks in practice, an exploratory study was conducted with respect to relevant MAR-Apps on Google Play.

TABLE 1
MAR-Apps with Security/Safety Issues.

| MAR-Apps | SI | SA | PL | Downloads | Rating |
|---|---|---|---|---|---|
| Pokémon GO | ✓ | ✓ | — | 100M | 4.1 |
| Jurassic World | ✓ | ✓ | — | 10M | 4.4 |
| Live | | | | | |
| The Walking | ✓ | ✓ | — | 5M | 4.2 |
| Dead | | | | | |
| Color Quest AR | ✓ | — | — | 1M | 3.6 |
| Snaappy | ✓ | ✓ | ✓ | 1M | 4.2 |
| AR Real Driving | ✓ | — | — | 500K | 4.2 |
| Just a Line | ✓ | — | — | 500K | 3.5 |
| Weapon AR | ✓ | ✓ | — | 100K | 3.9 |
| vTime XR | ✓ | ✓ | ✓ | 100K | 3.9 |
| WallaMe | ✓ | ✓ | ✓ | 100K | 3.6 |
| RealTag | ✓ | ✓ | — | 100K | 3.6 |
| Real Note | ✓ | ✓ | ✓ | 50K | 3.6 |
| My world | ✓ | ✓ | ✓ | 10K | 3.7 |
| Tendar | ✓ | — | — | 5K | 3.9 |
| MARK | ✓ | ✓ | — | 1K | 3.7 |

Dataset. Initially, potential MAR-Apps were located by running a search with relevant keywords, i.e., augmented reality, and exploring the results in the AR category as provided by Google Play. Next, the suitability of each candidate MAR-App for this study was determined by manually exploring the AR features implemented as a part of their run-time functioning, and by reading their corresponding documentation (if available). As shown in Table 1, a total of 15 out of 22 MAR-Apps were ultimately located, evaluated, and installed for experimental purposes on a Samsung S9 running Android 10 and a Motorola G6 running Android Pie. Also, for each MAR-App, the number of downloads, as well as the user rating, as reported by Google Play by March 2021, was also collected.

Methodology. The two devices were used to operate the MAR-Apps with different accounts and replicate multi-user interaction, one represented a benign entity while the other a malicious one. Through such a process, vulnerabilities and possible attacks were examined by attempting to use each of the studied MAR-Apps within a series of physical spaces for the Space Invasion attack. If the operation was possible, exposing Space Owners to intrusive MAR, an attack was carried out as successful. For Space Affectation attacks, the MAR content offered by the MAR-Apps was evaluated along with how it handled multi-user interaction. A successful attack was conducted by dangerous MAR content, and if the malicious user could compromise other's security via the MAR-App. Finally, at the evaluation examined how the MAR-Apps collect and handle sensitive information.

Results. As shown in Table 1, the surveyed MAR-Apps (15/15, 100%) were found to be vulnerable to Space Invasion as they executed in the physical locations, and there was no provided way to limit their operations. In addition, several of the surveyed MAR-Apps (11/15, 73.33%) were found vulnerable to Space Affectation. Some were geolocation-based MAR-Apps (e.g., Pokemon GO, Jurassic World, etc.) where the location assigned to MAR objects was publicly known. As described in § 3.2, this has led to security incidents. Others were social MAR-Apps with no limitations over where MAR content could be shared or published, e.g., Snaappy, RealTag, Wal-laMe, MARK, etc. One user left traces with hostile MAR content as digital graffiti, and the attack was possible if the other user could interact with such MAR content. Also, some of the MAR-Apps had violent MAR content, i.e., Weapon AR, leading to possible user experience degradation. Finally, some MAR-Apps demonstrated Privacy Leak Attacks (5/15, 33.33%) as they gathered sensitive information but did not handle it properly. For example, the user's current location was part of a public post without any warning.

### 4. Policy-Governed MAR-Apps

To prevent the security issues covered in § 3, the present disclosure outlines Policy-Governed MAR-Apps, which regulate MAR functionality at run-time. The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

4.1 Overview

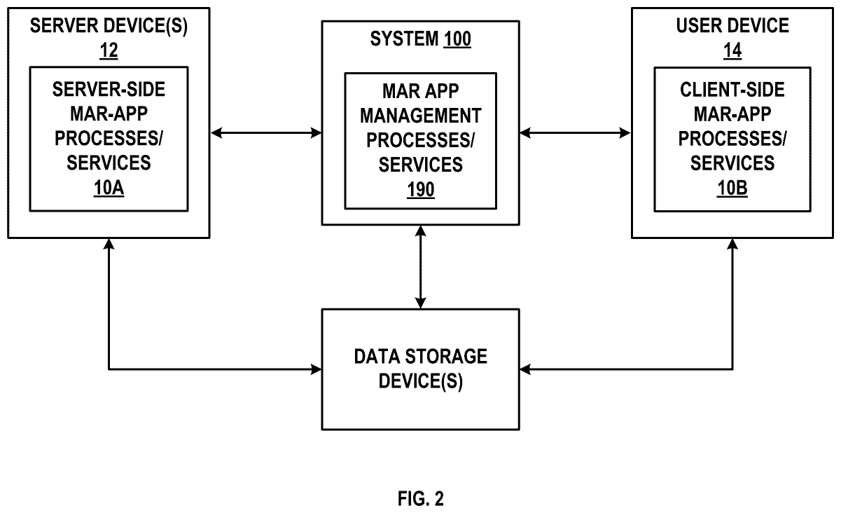

Referring to FIG. 2, a computer-implemented system (“system 100”) outlined herein is operable for mediating MAR-App content and other services with respect to user devices within a geographical boundary area. The system 100 can include MAR-App Management Processes/Services 190 that implements various processes and methods outlined herein for mediating content and interaction with an MAR-App (defined by “Provider-side” MAR-App Processes/Services 10A and “User-side” MAR-App Processes/Services 10B shown in FIG. 2). The system 100 communicate with one or more provider device(s) 12 that implement the Provider-side MAR-App Processes/Services 10A, and a user device 14 that implements the User-side MAR-App Processes/Services 10B. The provider device(s) 12 can be associated with an MAR-App provider, e.g., as a server or other system that hosts MAR-App content for delivery to a user associated with the user device 14. In some examples, aspects of the system 100 can be implemented at least in part using the user device 14, e.g., the User-side MAR-App Processes/Services 10B and the MAR-App Management Processes/Services 190 can operate on the same computing device within separate “apps” or a single integrated “app”. In other examples, aspects of the system 100 can similarly be implemented at least in part on the provider device(s) 12. Further, aspects of the system 100 could also be implemented in association with a network device that may be associated with the geographical boundary area, e.g., that communicates with both the provider device(s) 12 and the user device 14.

The Provider-side MAR-App Processes/Services 10A provides various services associated with the MAR-App including MAR object generation and “placement” within a geographical boundary area. The User-side MAR-App Processes/Services 10B can be in the form of an “app” running on the user device 14 that interfaces with the Provider-side MAR-App Processes/Services 10A associated with the provider device(s) 12 over a network. The User-side MAR-App Processes/Services 10B and can access information associated with the user device 14 such as but not limited to: a geographical location of the user device 14, an operating system and/or MAR-App version running on the user device 14, and other information associated with the user. The User-side MAR-App Processes/Services 10B displays MAR-App content to a user, including MAR objects that have been generated and “placed” within the geographical boundary area by the Provider-side MAR-App Processes/Services 10A. When the user device 14 is within the geographical boundary area, the user may be able to interact with MAR-App content that is available with the geographical boundary area. Further, the User-side MAR-App Processes/Services 10B can also provide various services associated with the MAR-App in addition to those provided from the Provider-side MAR-App Processes/Services 10A.

4.2 Policies and Policy Enforcement

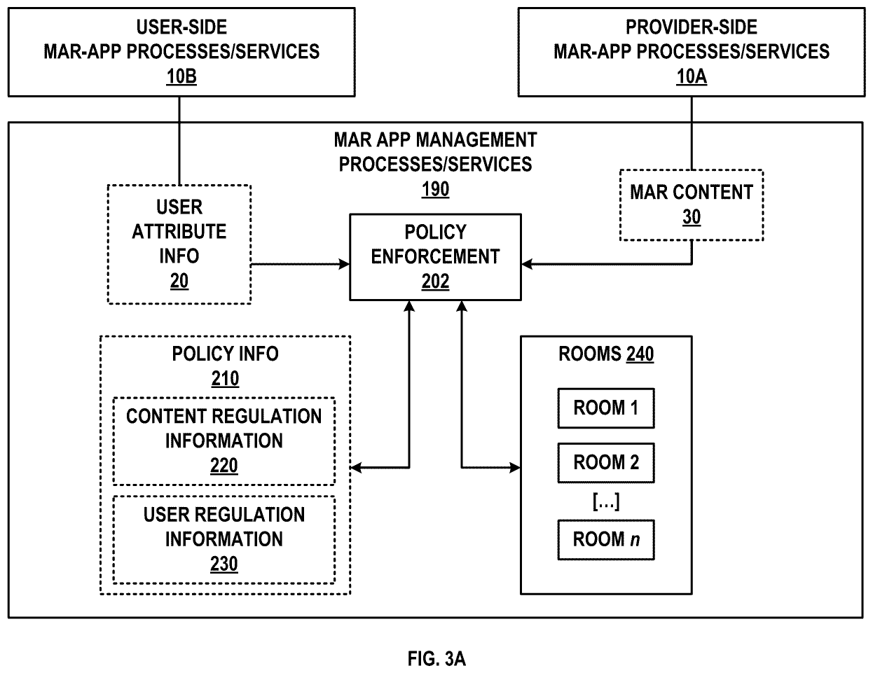

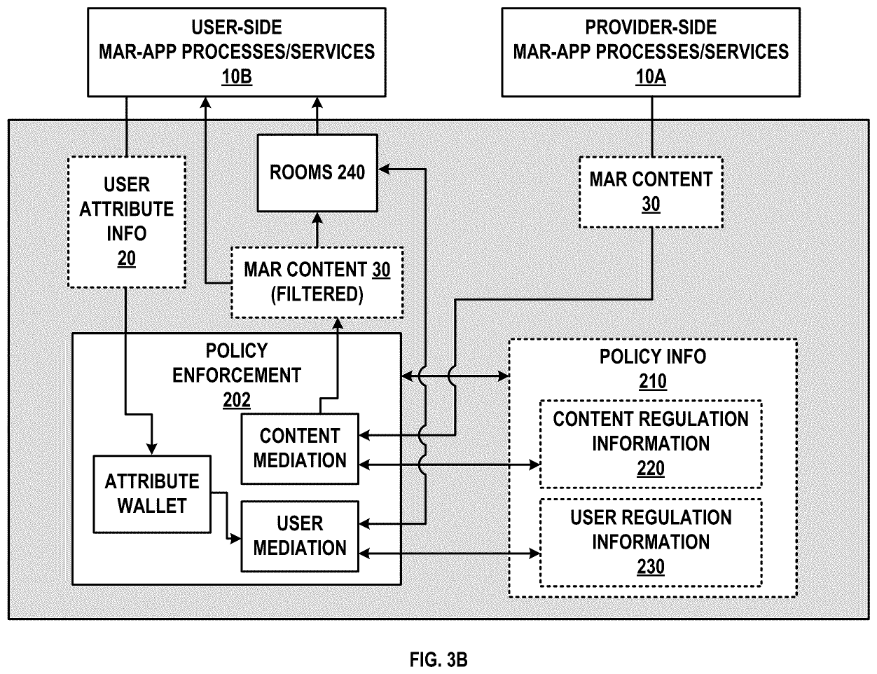

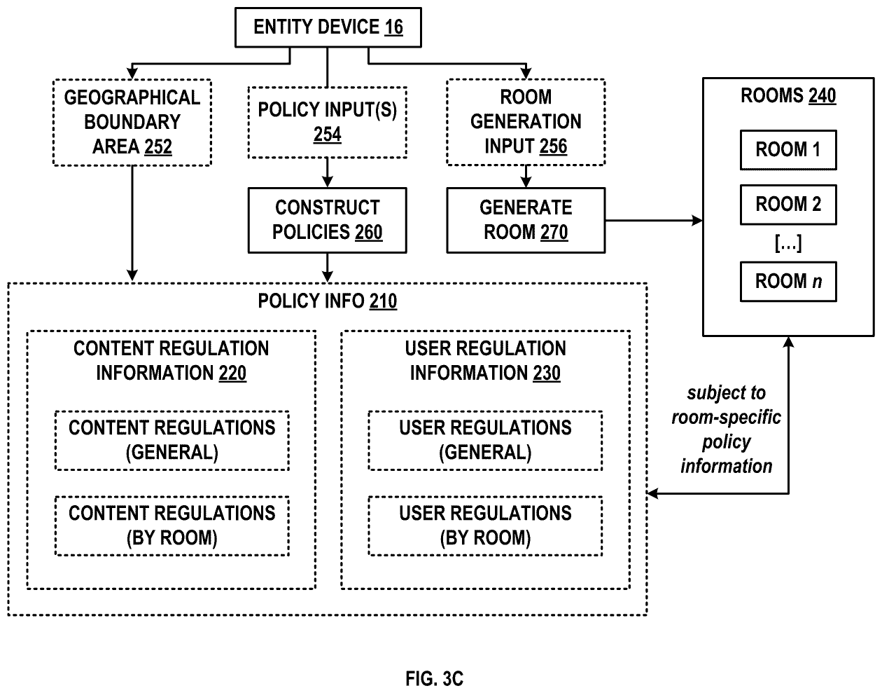

FIGS. 3A-3C elaborate on functionalities of the MAR-App Management Processes/Services 190 with respect to the MAR-App (e.g., the Provider-side MAR-App Processes/Services 10A and the User-side MAR-App Processes/Services 10B). The MAR-App Management Processes/Services 190 can store, manage, or otherwise access policy information 210, which includes information about various policies that regulate functionality of the MAR-App within a geographical boundary area.

Referring to FIG. 3A, the policy information 210 can include policies directed to the “Space Owner-Provider-User” mode of operation that regulate MAR content and usage in a protected space or geographical boundary area. These types of policies can be set by a Space Owner, but could also be set by the Provider, and/or the User with the aim of preventing “Space Invasion” attacks. In some examples, the policy information 210 may be applied as “blanket” policies for multiple different MAR-Apps that may run on the user device. For example, the MAR-App Management Processes/Services 190 can allow a Space Owner of a protected memorial facility to set policies that restrict content from all MAR-Apps except for their own educational MAR-App. In another example corresponding to usage of an in-store MAR-app, the MAR-App Management Processes/Services 190 can allow a Space Owner of a grocery store to set policies that restrict delivery of alcohol-related content of the MAR-app to underage users.

The policy information 210 can further include policies directed to the “User-Provider-User” mode of operation that regulate MAR content and usage between the user device 14 and the provider 12, as well as interactions with other users. These types of policies can be set by users, but could also be set by the Provider, and/or the Space Owner with the aim of preventing “Space Affectation” attacks and “Privacy Leak” attacks. For example, the MAR-App Management Processes/Services 190 can allow a user to set policies that establish MAR content and users they are willing to encounter.

In one example implementation, the MAR-App Management Processes/Services 190 can include a “Policy Enforcement” framework 202 that can provide the core functionalities involved in enforcement of the policies outlined in the policy information 210 with respect to MAR interactions within the geographical boundary area. The Policy Enforcement framework 202 can be implemented at a processor to perform operations including accessing the policy information 210 regulating functionality of the MAR-App within a geographical boundary area, and accessing user attribute information 20 associated with the user device 14. The user attribute information 20 includes values of one or more user attributes associated with the user device 14, such as geographical location of the user device 14, an age of a user associated with the user device 14, etc. Such information may be pertinent to enforcement of the policy information 210. In some examples, the Policy Enforcement framework 202 can implement Space-Sensitive Access Control (SSAC), discussed herein at § 5, to interpret and enforce policies with respect to user attributes.

The Policy Enforcement framework 202 can further be implemented at the processor to perform operations including facilitating communication between the provider device 12 associated with the MAR-App and the user device 14 based on the user attribute information 20. This includes regulating MAR content 30 distributed through the MAR-App, as well as regulating communications between the provider device 12, the user device 14, and devices belonging to other users. This can entail allowing or preventing, based on the policy information 210 and the user attribute information 20, operation of one or more services of the MAR-App at the user device 14 when the user device 14 is within the geographical boundary area.

The Policy Enforcement framework 202 can further be implemented at the processor to perform operations including facilitating communication between the provider device 12 associated with the MAR-App and the user device 14 based on the user attribute information 20. This includes regulating MAR content 30 distributed through the MAR-App, as well as regulating communications between the provider device 12, the user device 14, and devices belonging to other users. This can entail allowing or preventing, based on the policy information 210 and the user attribute information 20, operation of one or more services of the MAR-App at the user device 14 when the user device 14 is within the geographical boundary area.

With additional reference to FIG. 3B, the policy information 210 can include content regulation information 220 detailing one or more regulations on content (e.g., MAR content 30) distributed through the MAR-App to be enforced within the geographical boundary area. As shown in the example implementation of FIG. 3B, the Policy Enforcement framework 202 can include “content mediation” routines that filter MAR content 30 from the MAR app based on the user attribute information 20 with respect to the content regulation information 220, and facilitate communication between the provider device 12 and the user device 14 in view of the content regulation information 220 and the user attribute information 20.

In the example corresponding to the in-store MAR-App, the content regulation information 220 can indicate that the Policy Enforcement framework 202 is to prevent distribution of alcohol-related content of the MAR-App to user devices 14 within the geographic boundary area where the user attribute information 20 indicates they are underage or where the user attribute information 20 does not include their age.

The policy information 210 can further include user regulation information 230 detailing one or more regulations on user access to MAR-App services, including interactions with other users to be enforced within the geographical boundary area. As shown in the example implementation of FIG. 3B, the Policy Enforcement framework 202 can include “user mediation” routines that manage which user devices 14 can access one or more services of the MAR-App the MAR app based on the user attribute information 20 with respect to the user regulation information 230, and facilitate communication between the provider device 12 and the user device 14 in view of the user regulation information 230 and the user attribute information 20.

For example, a space owner may establish user regulation information 230 that indicates that the Policy Enforcement framework 202 is to prevent a user device 14 from interacting with one or more services of the MAR-App within the geographic boundary area if their operating system or app version is out of date. In another example, a school may write policies to prevent usage of non-educational MAR-Apps by students on campus during school hours (e.g., where the user attribute information 20 indicates that they are a student, indicates a geographic location of the device where the local time is within school hours, etc.), but may allow usage of age-appropriate MAR-Apps by students before or after school.

For a user requesting access to one or more services of the MAR-App at the user device 14, the Policy Enforcement framework 202 can generate an access request including the user attribute information 20 of the user device 14. Based on the user attribute information 20 in view of the policy information 210, the Policy Enforcement framework 202 can facilitate communication between the provider device 12 and the user device 14. This can include allowing or preventing interaction with or access to MAR content 30 or other users of the MAR-App based on the policy information 210.

4.3 Protecting User-User Interactions through Rooms

In some examples, the MAR-App Management Processes/Services 190 can establish one or more “rooms” 240 to be hosted in association with the provider device 12, where a “room” is a regulated MAR-App environment that the user device 14 can “join” to interact with MAR-App services. The rooms 240 enable the Policy Enforcement framework 202 to control interactions between users in accordance with the policy information 210, and may be established by individual users as well as Providers or Space Owners. Access to MAR content 30 distributed to the user devices 14 through the rooms 240 can be controlled by the Policy Enforcement framework 202.

Policy information 210 can extend to each room 240, and can include room-specific policies on content and users. The content regulation information 220 can include by-room content regulations (e.g., room content regulation information) that regulate MAR content 30 delivered through individual rooms. As such, based on the room content regulation information, the content mediation routines of the Policy Enforcement framework 202 can prevent operation of one or more services of the MAR-App with respect to the user device 14 when the user device 14 is within the geographical boundary area and when the user device 14 is associated with the room of the MAR-App. Likewise, the user regulation information 230 can include by-room user regulations (e.g., room user regulation information) that regulate which users can access individual rooms. The user mediation routines of the Policy Enforcement framework 202 can prevent, based on the room user regulation information and based on the one or more user attributes associated with the user device, access to the room by the user device.

For example, user devices 14 in a geographical boundary location may be required to select a “room” for the MAR-App before interacting with MAR content. A first room may be dedicated to kids, and may have age restrictions on which user devices 14 can access age-appropriate MAR content delivered through the first room. A second room may be dedicated to the public, but may have other types of restrictions on which user devices 14 can access MAR content delivered through the second room. The MAR content of the second room may be different from the MAR content of the first room.

For a user device 14 requesting access to a room 240, the Policy Enforcement framework 202 can generate an access request that includes the user attribute information 20 for access to the room 240 hosted in association with the provider device. Based on the user attribute information 20 in view of the policy information 210 (e.g., including both general user regulation information and room-specific user regulation information) that regulates user access to the room, the Policy Enforcement framework 202 can facilitate communication between the provider device 12 and the user device 14. This can include allowing or preventing interaction with or access to MAR content 30 delivered through the room 240 or with other users of the MAR-App that are associated with the room 240 based on the policy information 210.

4.4 Attribute Wallet

In some examples, the MAR-App Management Processes/Services 190 can provide services pertaining to an “attribute wallet” that enables the user to view and select which instances or types of user attribute information 20 that they allow to be shared with the provider device(s) 12. In particular, the MAR-App Management Processes/Services 190 can include instructions executable by a processor to request approval from the user associated with the user device 14 for access to the user attribute information 20 by the provider device 12. User-approved user attribute information 20 may be maintained by the MAR-App Management Processes/Services 190 as the attribute wallet that can be stored at a data storage device in association with the user device 14 and can be used to provide pertinent information to the provider device 12.

4.5 Policy Construction and Room Generation

FIG. 3C shows policy construction and room generation enabled by the MAR-App Management Processes/Services 190. To construct the policy information 210, a policy construction routine 260 of the MAR-App Management Processes/Services 190 accesses geographical boundary information 252 and policy input(s) 254 from an entity device 16 associated with an entity that is making a policy (e.g., a space owner, or alternatively a provider or a user). The policy construction routine 260 can be implemented through SSAC discussed herein at § 5. The policy construction routine 260 can generate and display a user interface that enables a policy-maker to define a sensitive space by entering the geographical boundary information 252 and to create constraints on MAR-App services within the sensitive space defined by the geographical boundary information 252. The policy construction routine 260 can further construct the policy information 210 regulating functionality of the MAR-App based on the policy input 254, e.g., such that the policy information 210 is readable by a processor implementing the Policy Enforcement framework 202, and store the policy information 210 at a data storage device in association with the processor.

To generate a room 240, a room generation routine 270 of the MAR-App Management Processes/Services 190 accesses a room generation input 256 from an entity device 16 associated with an entity that is making a room (e.g., a space owner, or alternatively a provider or a user). The room generation routine 270 can generate and display a user interface that enables a room creator to define one or more rooms 240 for access to one or more functionalities of the MAR-App within the sensitive space defined by the geographical boundary information 252. The policy construction routine 260 may be employed in combination with the room generation routine 270 to enable the room creator to define room-specific policy information, and to further construct the policy information 210 (e.g., including room user regulation information and room content regulation information) regulating user access to the room 240 and regulating functionality of the MAR-App for user devices 14 that are associated with the room.

### 5. Proof-of-Concept MAR-App “SpaceMediator”

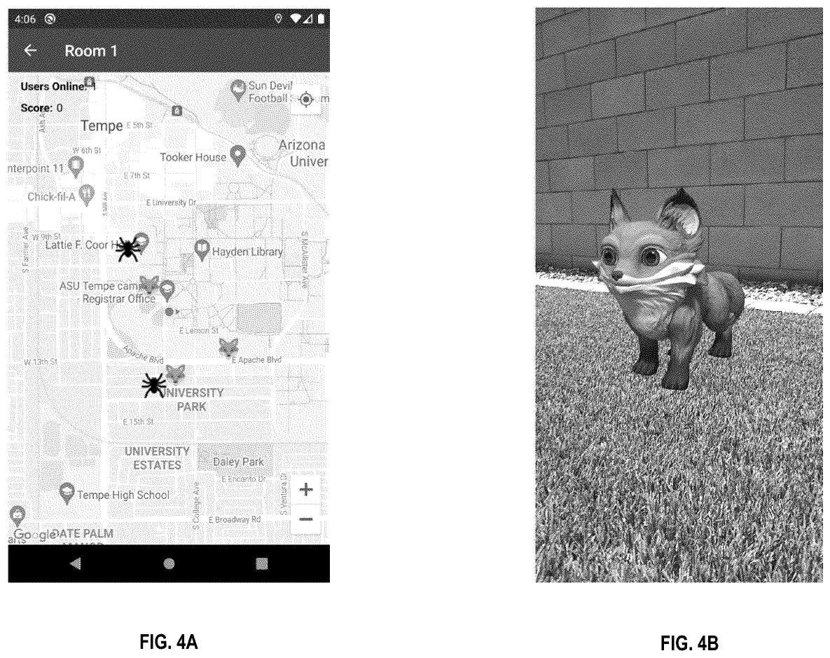

The approaches outlined herein were implemented via SpaceMediator, a proof-of-concept MAR-App shown in FIGS. 4A and 4B. SpaceMediator is developed in Android and implements Augmented Reality through Google's library ARCore. Also, SpaceMediator emulates geolocation-based MAR-Apps by assigning specific coordinates to MAR objects. For the purposes of illustration, content of such MAR objects is limited to “Foxes” and “Spiders” in the current version, as shown in FIG. 3B. Similar to the interaction of Pokemon GO, in SpaceMediator users move around different locations to capture the available MAR objects and score some points. The present disclosure starts by presenting the theoretical foundations of the present approach in § 5.1, and then elaborates on how they are implemented into SpaceMediator. Specifically, the present disclosure addresses regulation of sensitive spaces through SSAC, a mechanism to regulate MAR-Apps over claimed physical spots in § 5.2, restrictions over user interaction through Rooms in § 5.3, and privacy of users in § 5.4.

5.1 A Model for Policy-Governed MAR-Apps

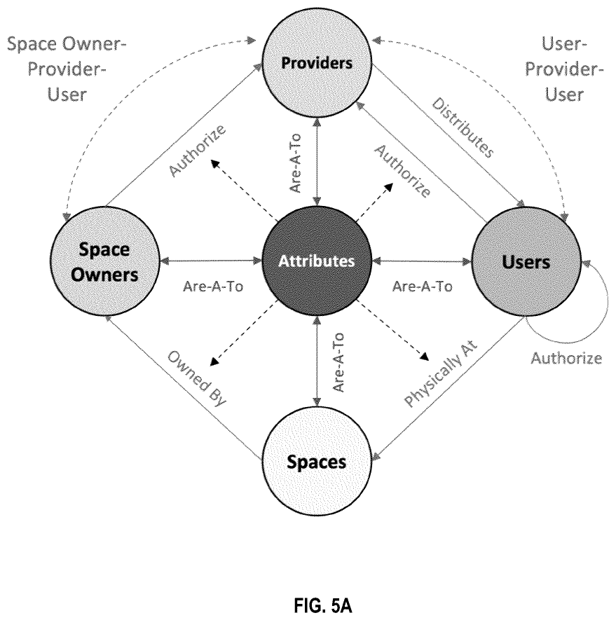

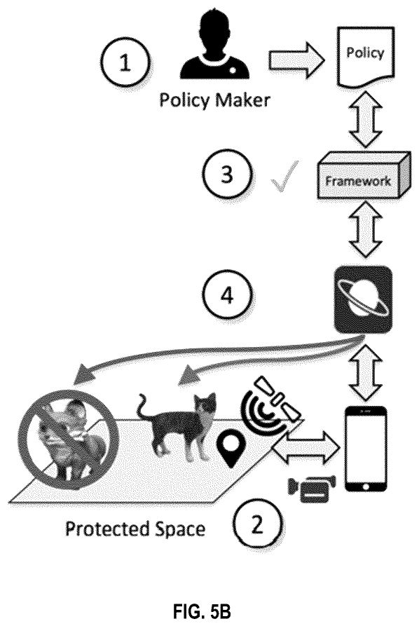

In order to effectively implement Policy-Governed MAR-Apps, it was necessary to develop a theoretical model detailing how MAR content is generated, distributed, and eventually delivered to Users. That way, restrictions can be specified to decide what content is displayed within the physical spaces they control, e.g., a player controlling if he/she is visible via a 3D avatar to other players over a specific space. FIG. 5A shows one model including a set of Entities associated with attributes that distinguish them, a set of MAR-related Functionalities, as well as different Modes of Interaction relating Entities and Functionalities.

Attributes. Attributes are a convenient abstraction that can be used for representing the different pieces of security-relevant information required for Policy-Governed MAR-Apps. Attributes are typically composed of 3-tuples consisting of (i) a unique identifier (ID), e.g. age, (ii) a datatype, e.g., integer, and (iii) a set of values over the range defined by the datatype, e.g., the range of 0-110 to denote the age of a human being. In addition, attributes may also be obtained from multiple different sources: government, companies, schools, makers, etc.

For example, overlapping of digital content over video streams can be modeled as (ARDigitalObject, object.type, {“gaming.object”}), where ARDigitalObject is a custom-made type intended to model space-sensitive functionality. In addition, a protected space can be defined by a customized attribute of the form (GPSPolygon, campus, {“X,Y,W,Z”}) where GPSPolygon defines a spatial structure in the form polygon composed of GPS coordinates, which are then labeled as X, Y, W, and Z for illustrative purposes. Attributes may be in turn origi-nated from different sources, e.g., external organizations or institutions, the MAR-Apps themselves, or even the supporting devices such as smartphones. As an example, an attribute (String, app.name, {“MyApp”}) can be provided by the corresponding MAR-App itself, and collected at runtime when authorization is requested within a given protected space.

Authorization Policies. Policies of an MAR-App are then written using attributes obtained from users, e.g., a person using an MAR-App, the MAR-Apps themselves, the hand-held devices, the physical spaces, e.g., home or a park, as well as some other relevant aspects such as time. This way, authorization to distribute MAR content is only granted if all attributes listed in a given policy are shown by the requesting MAR-App at runtime. In some examples, policies restricting MAR Content are defined by means of a series of predicates relating Entities, Spaces, and Attributes. For instance, the predicate Authorizes(U₁, U₂, C, S, P) denotes the case when User U₁ has authorized the distribution of MAR Content C to User U₂, which is carried out by Provider P under the context of the Space S.

Using attributes, authorization policies can be constructed for restricting functionality in space-sensitive MAR-Apps. In SSAC, access rights (permissions) are modeled by combining attributes depicting space-sensitive functionality along with a set of operations that can be performed over them. As an example, a simple<allow>operation may be used to model an access right effectively allowing some customized functionality such as the aforementioned (ARDigitalObject, object.type, {“gaming.object”}). In addition, the protected spaces can be specified using attributes, e.g., the (GPSPolygon, campus, {“X,Y,W,Z”}) attribute discussed before. Moreover, policies define the attributes that are required for access rights to be granted or denied. Returning to the running example, a policy may combine the aforementioned attributes along with an attribute depicting affiliation to a given university, e.g., (Membership, associate.type, {“Student”}). This way, such a policy will allow for digital objects to be displayed within the protected space comprising a university campus only if the following are met: the requested space-sensitive functionality matches the object.type attribute described above, the protected space the end-user is located at a given moment of time can be identified by the campus attribute, and the end-user running the MAR-App happens to be an affiliated student. As shown in FIG. 5B, such attributes are to be collected at runtime and forwarded to an implementation framework, along with an authorization request, when the end-user approaches a protected space with an MAR-App activated on a supporting device.

SSAC can require a consensus on attribute names, data types, and semantics, so consistency can be guaranteed within the context of a given implementation, e.g., all involved participants should have a clear understanding of the attributes being used, their semantical context, as well as their originating sources, such that the authorization process can be successfully conducted. In such a context, some implementations may require for attributes to be asserted by their originating sources, e.g., a university digitally signing an attribute depicting student membership, in such a way that both the origin and the integrity of such attributes can be better assessed.

Moreover, SSAC differs from other approaches considering attributes for authorization decisions such as XACML. One of the major differences resides in the lack of support for specifying attribute-based constraints, e.g., requiring the value of a given attribute to be within a certain range. Such a design decision was based in the pursuit of a model that can be easily understood by all participant actors, e.g., policy makers and end-users, etc. However, there may be cases in which such constraints may be required. As an example, consider a policy that requires end-users to be 21 or older of age. Also, assume an attribute named enduser.age, which ranges over integer values starting from 0 all the way up to 120, is also available. This way, policy makers leveraging SSAC may need to enlist all attribute 3-tuples ranging from 21 to 120 when crafting the aforementioned policy. On the other hand, an alternative approach considering attribute-based constraints may only require an expression of the form “enduser.age >=21”, thus significantly improving the convenience for policy makers without sacrificing expressiveness.

In order to overcome these limitations, the present disclosure proposes establishing a dedicated repository, hereafter referred as an attribute catalog, which includes standardized definitions for the attributes they provide, e.g., names, data types, as well as a natural language description. In addition, such an attribute catalog may also introduce attribute transformations that take some attributes as an input and produce some other attributes as a result. As an example, a transformation may be provided such the enduser.age attribute can be turned into a (Boolean, enduser.ismajor, {“true”}) attribute if and only if the value of the enduser.age attribute is equal or greater to 21. These attribute transformations can be in turn implemented in practice as independently-developed modules, e.g., web services, that can be dynamically selected and instantiated at will. Also, they may be provided by either attribute sources, policy makers, or any other trusted participant in the context of an implementation of SSAC.

Using attribute catalogs, not only a clear definition of attributes is available, but also enhanced convenience and flexibility is provided. During policy specification time, makers can select the attributes that better describe their authorization needs. In addition, makers may also select a set of attribute transformations that may ultimately produce the attributes listed in their policies. During policy evaluation time, transformations may be automatically instantiated, e.g., invoking a web service, based on the attributes included in the evaluation request. If successful, any produced attributes are returned and used to evaluate the policy.

Entities and Functionalities. Following the model of FIG. 5A, the Entities and the MAR-related Functionalities comprised within the model can be described as follows:
Providers. A Provider is an Entity primarily associated with generating, e.g., developing and maintaining a MAR-App. Generally, they can be related to attributes such as IP addresses as mobile apps are associated with servers. In addition, they distribute MAR content for user interaction inside Spaces.
Users. The Users are the Entities who regularly operate a MAR-App. Therefore, they are the ones who interact with the supplied MAR content. As each User is unique, they are associated with attributes that distinguish them or personal information, e.g., ID, name, date of birth, etc. In a Policy-Governed MAR-Apps, Users shall have the opportunity to authorize who they interact with if multi-user interchange is possible and regulate MAR content.
Spaces. A Space represents the physical location of Users while interacting with MAR. As previously discussed in § 2.1, MAR merges 3D digital content and the physical world. Therefore, leading to virtual manipulation or alteration of the surrounding. Some attributes that identify Spaces may include a set of geographical coordinates, distance, altitude, etc.
Space Owners. Finally, the Space Owners are the Entities who have the right of deciding if MAR content can be displayed inside a Space, therefore, they are said to own a Space. There is a wide range of possible Space Owners as MAR can influence various areas, e.g., parks, museums, businesses, residential areas, schools, etc. They are associated with attributes that assist in distinguishing them since each one is unique, e.g., ID, name, etc. Space Owners shall be able to avoid unwanted MAR content and antagonistic behavior on their property. In this disclosure, space ownership is assumed to have been previously determined by external means.

For instance, the predicate Generates(U, C, P) can denote the case when a User ∪ generates MAR Content C and uploads it to the infrastructure of Provider P. In another example, a predicate IsPhysicallyAt(U, S) can denote the case when a User ∪ is located inside Space S.

Modes of Interaction and Attacks. To recapitulate, this disclosure has described the Entities involved in the model, their roles, how attributes are suitable to identify them, and their essential relationships with one another. This section further outlines how the implementation of authorization policies prevents security issues. It is worth examining the two Modes of Interaction that result from the presented regulations among Entities:
Space Owner-Provider-User: Space Owners set regulations over MAR content and usage in a sensitive space, a claimed area, to Providers. Afterward, Providers will consider such regulations before delivering MAR to Users within the established sensitive space. As a result, Users are limited to authorized interactions within the specified boundaries. Therefore, the enforced restrictions potentially prevent the Space Invasion Attack.
User-Provider-User: Users shall also establish regulations to Providers over the operation of the MAR-Apps that might impact them. Overall, they must regulate two parameters. First, the scope of MAR content they authorize for interaction. Then, if the MAR-App has multiplayer interaction, Users shall establish who they are willing to encounter. As a result, Providers will only distribute benign MAR content and avoid user-to-user interaction with unwanted parties. Therefore, limiting malicious third-parties exposure via MAR and potentially preventing the Space Affectation Attack. Likewise, Users must control the data MAR-Apps collect from them. They must be aware of any gathered sensitive information and manage to deliver it to Providers according to their will. Thus, stopping unawareness of personal data received by third parties and potentially preventing the Privacy Leak Attack.

As an example, the predicate User-Provider-User (U₁, C, P, U₂, S) can denote an interaction in which a User U₁ generates MAR Content labeled as C, which is then uploaded to a Provider P, and later distributed to another User labeled as U₂ in the context of a Protected Space S. More specifically:

User-Provider-User (U₁, C, P, U₂, S)
Generates (U₁, C, P),
Distributes (P, C, U₂),
IsPhysicallyAt (U₂, 3),
RendersAt (C, P, S)

A content mediation model of the system 100 can define attacks as modes of interaction between entities for whom authorization has not been granted. For instance, the predicate Space-Affectation (U₂, C, U₁, P, S, SO), denotes the case when MAR Content C, generated by User U₁, is distributed to User U₁ in an unauthorized way by Provider P over Space S, which in turn is managed by Space Owner SO. More specifically:

Space-Affectation (U₂, C, U₁, P, S, SO)
User-Provider-User (U₁, C, P, U₂, S),
Authorizes (SO, U₁, C, S, P),
Authorizes (SO, U₂, C, S, P),
!Authorizes (U₁, U₂, C, S, P),

5.2 Regulating Sensitive Spaces

As previously explained in § 3.2, the sensitive spaces are areas exposed to Space Invasion attacks by mishandled MAR. Therefore, it is necessary to offer Space Owner, the entities in charge of such sites, the possibility to regulate the operation of the MAR-Apps within such locations. As a result, SpaceMediator was used to implement the Space Owner-Provider-User Mode of Interaction described in § 4.2 and 5.1, such that Space Owners are capable of enforcing restrictions over their sensitive spaces.

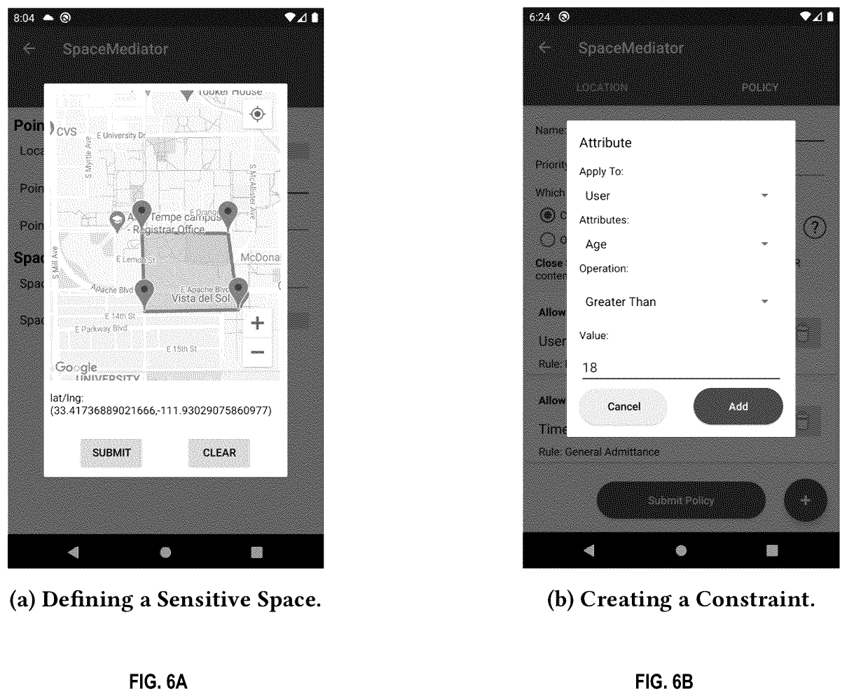

Policy Creation. Space Owners write policies to establish how they want to regulate MAR-App operations over their claimed sensitive space. This process starts with Space Owners specifying their claimed area via geographical points, where the policy will go into effect, as shown in FIG. 6A). Then, they select the regulation type they want to implement in the policy, which will decide the policy's combining algorithm and rules' effect. There are two regulation types offered in SpaceMediator to offer a wider variety of possible policies. First, the Open Space, designed for Space Owners with low restrictive parameters, which is compatible with the XACML policy featuring the permit-unless-deny rule combining algorithm with Deny rules. Second, the Close Space facilitates high restrictive constraints, resulting in an XACML deny-unless-permit policy with Permit rules. Finally, as displayed in FIG. 6B, they specify the attributes they want as part of the policy, e.g., Age >18, Username=User1, Time≤12:00:00, etc.

It is important to point out that whether such attributes are permitted or denied depends on the selected regulation type. Therefore, let us look into each of the mentioned regulation types, i.e., policy structure and rules.

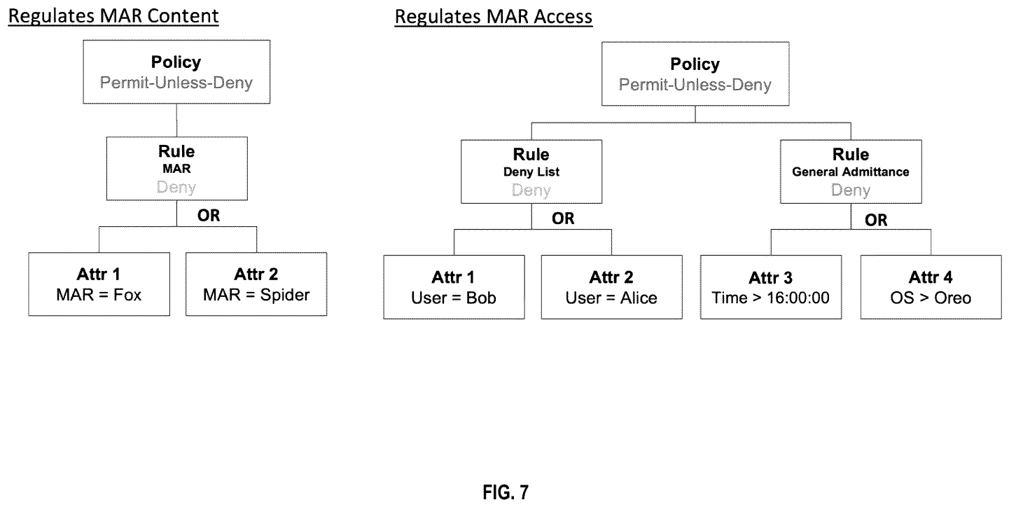

Open Space. This regulation includes two policies used for different purposes. Selecting an Open Space implies a predefined structure for these policies. As shown in FIG. 7, both have an XACML permit-unless-deny combining algorithm, rules with Deny permission, and attributes appended by OR logical operators. As a result, met statements in the policy result in a Deny authorization when evaluated, otherwise in a Permit. Therefore, Space Owners just define reject parameters through an Open Space.
MAR Distribution Policy. In SpaceMediator, this policy describes how to handle MAR content within a sensitive space. It is used throughout MAR object distribution from the Provider.
MAR Interaction Policy. In SpaceMediator, this policy controls users' interaction with available MAR objects within a sensitive space. There are two rules applicable to users:
   (1) Deny List Rule. This rule includes unauthorized usernames that shall not interact with the available MAR objects within the sensitive space.
   (2) General Admittance Rule. This rule considers attributes that apply to all users, e.g., Time, OS Version, Device Manufacturer, etc. Those who meet any of the specified conditions in this rule shall be unauthorized.

Close Space. The structure of Close spaces is very similar to Open Spaces. It also includes two policies, but the resulting limitations are different as it utilizes an XACML deny-unless-permit combining algorithm, rules have Permit permission, and the General Admittance Rule has its attributes appended by AND the logical operators. Therefore, these are more restrictive as policy statements are used are requirements for authorization, and failing to meet them results in denial. Although, the two policies within a Close Space hold the same purpose as in an Open Space.

5.3 Regulating Users Interaction

As previously mentioned in § 3.2, malicious parties have compromised the security of users by exploiting the known locations of MAR objects in multi-user geolocation-based MAR-Apps. Thus, to possibly prevent such scenarios and Space Affectation overall, SpaceMediator was used to implement the User-Provider-User Mode of Interaction, described in § 5. As a result, MAR objects distribution among users is done through Rooms: isolated and regulated MAR environments for users to join (see also § 4.3).

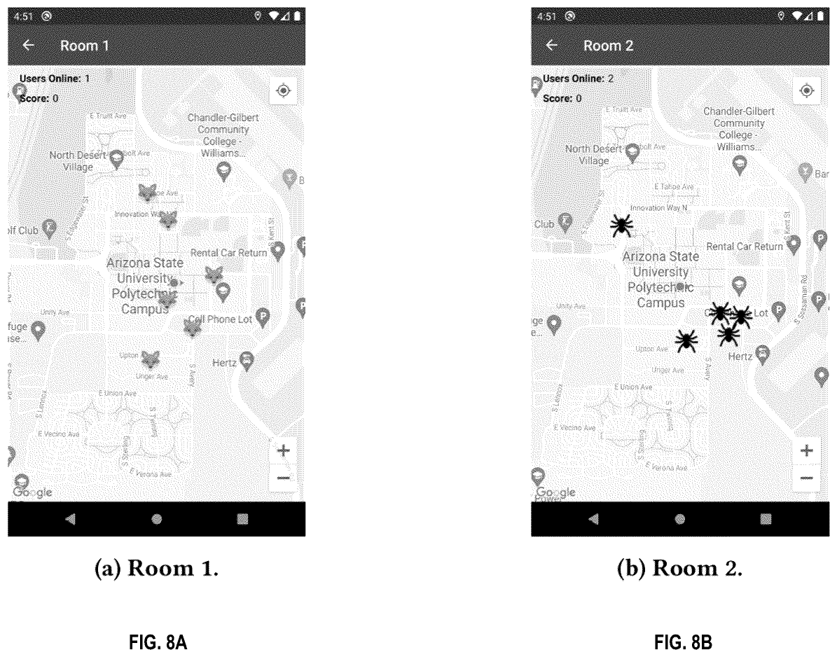

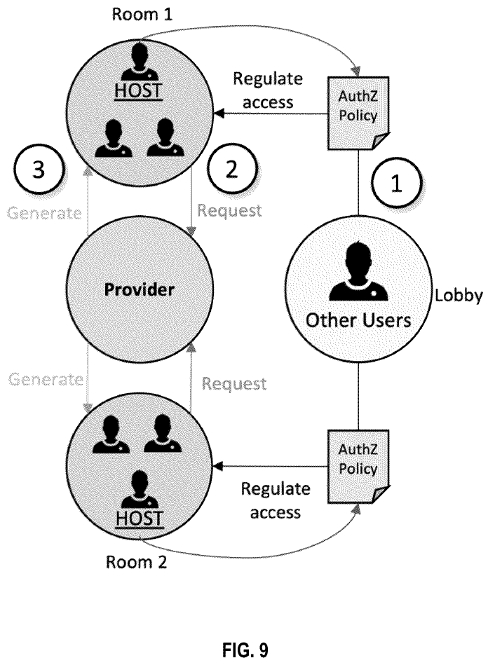

Rooms. Regulating multi-user interaction brings alongside the challenge of assembling an easy-to-use process for users. Because of this, SpaceMediator implements such regulations through Rooms, an extra layer to protect users from Space Affectation. Through them, users are separated into different groups, they decide whom to interact with, access is restrained, and each Room is provided with unique MAR objects for interaction. In addition, SpaceMediator offers a Lobby that displays the available Rooms and applicable constraints. At the Lobby, users select a Room to join or create a new one, implementing their desired user interaction regulations. Afterward, users enter a Room and operate SpaceMediator by capturing available MAR objects. Rooms are isolated as a user can only be in one Room at a time, and the MAR objects provided to each Room are distinct. Also, they are regulated as they have admission requirements for users, and it filters the content of MAR objects to avoid undesirable ones. As shown in FIGS. 8A and 8B, the two Rooms available in the Lobby are provided with their respective MAR objects for interaction, and the location and content of such MAR objects vary since Room 1 only allows foxes while Room 2 rejects them. There could be several users within a Room, but only one with the role of HOST establishes the applicable policies. Rooms implementation through SpaceMediator is reflected in FIG. 9, and can be outlined in the following three steps:

(1) Join Room: Users find available Rooms through a Lobby. There they try joining an existing Room, regulated by the HOST's policies. For example, a Room could only allow underage players. Users could also create new rooms if unable to join any.

(2) Room Interaction: Users request new MAR objects for interaction within the Room. For example, such demands are generated as they move to distinct locations where no MAR objects are available. In general, SpaceMediator submits automated requests to the Provider for new MAR objects to keep users entertained.

(3) Regulated MAR: If the new content request is authorized, the Provider distributes new MAR objects within the Room.

Policy Creation. In SpaceMediator, the user assigned the HOST role is in charge of a Room's policy. This role is automatically appointed to whoever created a Room, and it is reassigned in a First-In-First-Out order if the HOST leaves. Thus, users efficiently implement their desired regulations by creating a Room in Space-Mediator's Lobby (as discussed in § 4.5). Besides, there is no limitation on having one HOST per Room as creating a new Room is a simple process. Space-Mediator offers two regulation types for User Interaction: Open Interaction and Close Interaction, which define the structure of the policies. Overall, these structures' design is the same as those used for Open and Close Spaces, as shown in FIG. 7, as the apply the same combining algorithms, rules' permission effect and relations among attributes. Although, the policies have a different purpose.
MAR Distribution Policy: The Provider evaluates this policy when distributing MAR objects to a Room, omitting intrusive MAR content that degrades the HOST experience.
MAR Interaction Policy: This policy evaluates users who want to join a Room. Thus, only authorized personnel by the HOST may enter and view available MAR objects.

5.4 Respecting Privacy

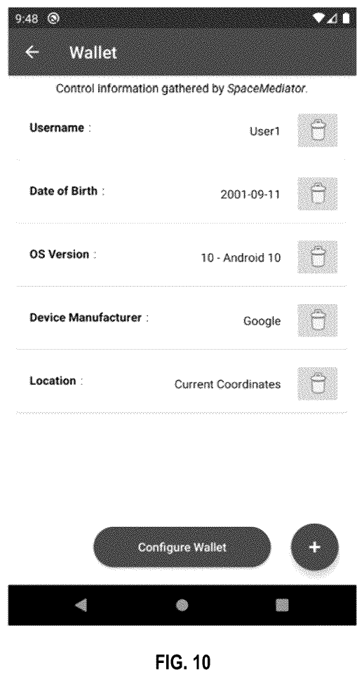

MAR-Apps are also vulnerable to Privacy Leak issues when gathering data from users, as explained in § 3.2. Likewise, SpaceMediator collects data from its users, for example, as they move around to interact with MAR objects. Furthermore, information is retrieved from users to create an access request, which contains valuable facts for authorization decisions as it is evaluated against a policy, as described in § 2. Therefore, to respect users' privacy while enforcing regulations, SpaceMediator was used to implement the Attribute Wallet (§ 4.4), graphically shown in FIG. 10. Through it, users are aware of any information gathered from them. To this end, all data used throughout SpaceMediator is within the Attribute Wallet's scope. Most of it is utilized for authorization purposes and represents attributes, e.g., birth date, device manufacturer, current geographical coordinates, etc. The Attribute Wallet also allows users to stop SpaceMediator from collecting sensitive information they do not want to provide. Although, there is data outside the Attribute Wallet's range as it is appended at the servers, i.e., time. Users' privacy is respected in SpaceMediator, as there is clarity over the compiled information, and users can control it.

In some examples, attribute wallets may be implemented as a submodule of policy-governed MAR-Apps or as an independent application running on the end-user's device, e.g., a smartphone. Using such wallets, end-users may be able to store attributes issued on their behalf by sources. Moreover, wallets may also allow for end-users to specify their preferences with respect to a subset of the attributes included within their wallets, which will be ultimately forwarded along with an authorization request. Such subsets, hereafter referred as attribute bags, provide end-users with a simple-yet-effective privacy management scheme that may restrict the amount of personal info that gets ultimately shared with policy evaluation engines at a given time.

As an example, the aforementioned attribute depicting (Membership, associate.type, {“Student”}), may be issued by a university on behalf of a given end-user, which then stores it inside an attribute wallet. Later on, upon approaching the university's protected space, the end-user may configure an attribute bag to release such an attribute for policy evaluation. This way, previously-defined bags may allow for attributes to be used when evaluating authorization policies, without requiring an interaction with an end-user every single time, assuming attributes remain valid over a certain period of time. In addition, in case authorization is denied for a given protected space, end-users may interactively select some other attributes from their wallets, assuming those attributes were not included in previous attempts.

The following outlines example syntax and data structures associated with interpretation of the user attribute information and policy information.

Attribute Equality. An attribute a is considered to be equal to another attribute a′ if the following conditions are met: first, the data type and the name components of both a and a′ are the same, and, second, the set of values of a is a subset of the set of values defined for a′, that is, values (a)⊆values (a′).

Attribute Catalogs. An attribute catalog C=(S−ATTRS, SP−ATTRS, A−ATTRS, O−TTRS, T) includes the sets of attributes, as well as the set of attribute transformations T (defined below), that are available within a given implementation.

Attribute Wallets and Bags. An attribute wallet W=(S_{W}, SP_{W}, A_{W}, O_{W}), is a 4-tuple data structure listing subsets of the attributes included within a given catalog C, such that S_{W}⊆S−ATTRS, SP_{W}⊆SP−ATTRS, A_{W}⊆A−ATTRS and O_{W}⊆0−ATTRS, An attribute bag B=S_{B}∪SP_{B}∪A_{B} ∪O_{B} is a subset of the attributes included within a given attribute wallet W, such that S_{B}⊆S_{W}, SP_{B} ⊆SP_{W}, A_{B} ⊆A_{W}, O_{B} ⊆O_{W}.

Attribute Transformations. An attribute transformation is modeled as a mathematical function of the form t: A→A, where A is a powerset of S−ATTRS ∪SP −ATTRS ∪O −ATTRS ∪ENV −ATTRS. An attribute transformation t takes as an input a non-empty set of attributes, labeled as input(t) and returns a possibly empty set of output attributes, labeled as output(t), as a result.

Attribute Chains. Given a set of attribute transformations T_{C} ⊆T and an attribute bag B, an attribute transformation chain, labeled as chain (T_{C}, B) is a partial ordering in T_{C}, such that for 0≤i<|T_{C}| and tᵢ, tᵢ₊₁ C chain (T_{C}, B), input (tᵢ₊₁)⊆Bᵢ, where Bᵢ=output(tᵢ) ∪Bᵢ₋₁ and B₀=B. For a given chain(T_{C}, B), input(chain(T_{C}, B))=input(tₒ) ∪B and output(chain(T_{C}, B))=output(tₙ) for n=(|T_{C}|−1).

Access Requests and Effective Attributes. An access request R=(B, OP_{R}) is a 2-tuple including an attribute bag B along with an operation OP_{R} ⊆OPER. In addition, the set of effective attributes for a given access request R=(B, OP_{R}) and a set of attribute transformations T_{C} is given by effective −attrs(R,T_{C})=B ∪ output (chain(T_{C},B)).

Authorization Policies. A policy POL is a 6-tuple data structure listing subsets of attributes included within an attribute catalog C, such that POL=(Sₚ,SP_{P}, O_{P},OP_{P}, T_{P}),where Sₚ ⊆S −ATTRS,SPₚ ⊆S SP −TTRS, A_{P} ⊆A−ATTRS, Oₚ ⊆O−ATTRS and T_{P} ⊆T. Also, it includes a subset of operations OP_{P} ⊆OPER.

Policy Evaluation Strategy. Finally, given a protected space S a policy POL restricting space-sensitive functionality on S, an attribute catalog C=(S−ATTRS, SP −ATTRS, A −ATTRS, O−−ATTRS, T), and an access request R on S, Grant−Access (S, POL, R) is a Boolean function that evaluates to True iff OP_{P}, =OP_{R} and Sₚ ∪SPₚ ∪A_{P} ∪Oₚ ⊆effective−attrs(R, T_{C}) for some T_{C} ⊆T. Otherwise, Grant −Access (S, POL, R) returns False as a result.

### 6. Evaluation and Results

This section presents the methodology and the results of a user study conducted to examine feasibility of a Policy-Governed MAR-App. This section starts with a general overview in § 6.1, covering objectives, implementation methods, and evaluation techniques. It concludes by presenting and discussing the results in § 6.2.

6.1 User Study

As previously discussed in § 3, several MAR-Apps are available across the different mobile operating systems with millions of downloads, growing popularity, and vulnerability to space and privacy attacks. In the present approach to prevent these attacks, users are allowed to regulate the functionality of a MAR-App. It intends to be helpful to all users, regardless of their prior knowledge, e.g., access control, computing, etc. To verify the feasibility of a Policy-Governed MAR-App following the present approach, a user study was conducted involving seven research questions (RQ):
RQ1 Can participants understand the concepts of space invasion, space affectation, and privacy leak attacks?
RQ2 Can participants identify security issues, with respect to the three attacks just mentioned?
RQ3 Can participants write effective Space Protection Policies?
RQ4 Can participants write effective User Interaction Policies?
RQ5 Can participants understand the policies to counteract space attacks?
RQ6 Can participants utilize the attribute wallet properly?
RQ7 Do participants agree with the regulation of MAR-Apps?

Participants and Methodology. For this study, 40 participants were recruited through advertisements placed throughout the university campus. Furthermore, the participant recruitment process focused on having participants with distributed background knowledge to identify if prior familiarity with computing was necessary to properly utilize a Policy-Governed MAR-App. As a result, half of the participants identified as having a background in Computer Science (CS). In contrast, the other half pursued degrees in different fields (Non-CS), e.g., engineering, arts, business, etc. The user study was conducted in timeframe group sessions with an average of 60 min. Through them, data from participants was gathered anonymously to evaluate the efficiency of the present approach to regulate MAR-Apps to prevent space and privacy attacks. The procedure implemented in each group session throughout the user study consisted of three phases: introduction, MAR-App interaction, and a questionnaire. Participants had a basic knowledge on relevant topics, used SpaceMediator when ready, and provided feedback, all within a reasonable timeframe to maintain focus.

Phase 1: Introduction. In this first phase of the user study, within 15 minutes, the project's scope was explained to participants. This covered topics such as the current status of MAR-Apps, security issues triggered by MAR-Apps (§ 2.2), vulnerabilities on MAR-Apps (§ 3), the present approach to preventing such vulnerabilities (§ 4, 5), etc. The first phase aimed to ensure understandability regardless of familiarity with cybersecurity. By the end of the introduction, participants needed to understand MAR, its vulnerabilities, and the regulations implemented in SpaceMediator.

TABLE 2
SpaceMediator Regulations.

| Policies | Rules | Attributes | Operations |
|---|---|---|---|
| Distribution | MAR | Content | = |
| Interaction | Permit/Deny | Username | = |
| | Admittance | Age | >, ≥, <, |
| | | OS Version | >, ≥, <, |
| | | Manufacturer | = |
| | | Time | ≥, ≤ |
| | | Other | = |

TABLE 3
User Study Policy Exercises.

| ID | Policy Description | Regulation |
|---|---|---|
| 1 | At the university campus, block spiders | Open Space |
| | MAR content, and deny Eve or anyone | |
| | with an OS less than Android Pie. | |
| 2 | At the college building, allow spiders | Close Space |
| | MAR content and grant access to adults | |
| | only after 6:00 p.m. or Bob. | |
| 3 | Within the room, allow MAR content | Close |
| | of foxes and grant access to university | Interaction |
| | students. | |
| 4 | Deny access to Eve or anyone else | Open |
| | who has a Samsung device, is underage, | Interaction |
| | or has an OS version less than Android 10. | |

TABLE 4
Questionnaire Policy Making-Sensitive Space.

| Policy Description | Answer |
|---|---|
| At the university campus allow foxes and | — |
| deny interaction with users who are over | |
| 16 years of age after 4:00 p.m. | |
| At the university campus allow foxes and | ✓ |
| authorize interaction with users who are | |
| over 16 years of age after 4:00 p.m. | |
| At the university campus allow foxes and | — |
| deny interaction with users who are less | |
| than 16 years of age after 4:00 p.m. | |
| At the university campus allow foxes and | — |
| authorize interaction with users who are | |
| over 16 years of age before 4:00 p.m. | |

Phase 2: MAR-App Interaction. Once participants were familiar with the purpose of the project and the essential topics covered within it, participants were asked to use SpaceMediator, the proof-of-concept MAR-App with regulated functionality outlined herein. Using SpaceMediator, participants followed a set of predefined exercises to write four policies. Table 3 shows the English-written policy descriptions provided to the participants that specified the authorized or unauthorized entities. As a result, each participant wrote two policies to prevent space invasion as Space Owners of a specified location and two to avoid space affectation by regulating user interaction in a room. The crafted policies were associated with an account given to each participant, stored in a database, and analyzed afterward. With Space-Mediator installed on four different devices, participants could complete these exercises in an average of 30 min. These devices included two Google Pixel 3XL with Android 11 and 4 GB of RAM, a Samsung S9 with Android 10 and 4 GB of RAM, and a Motorola G6 with Android Pie and 2 GB of RAM.

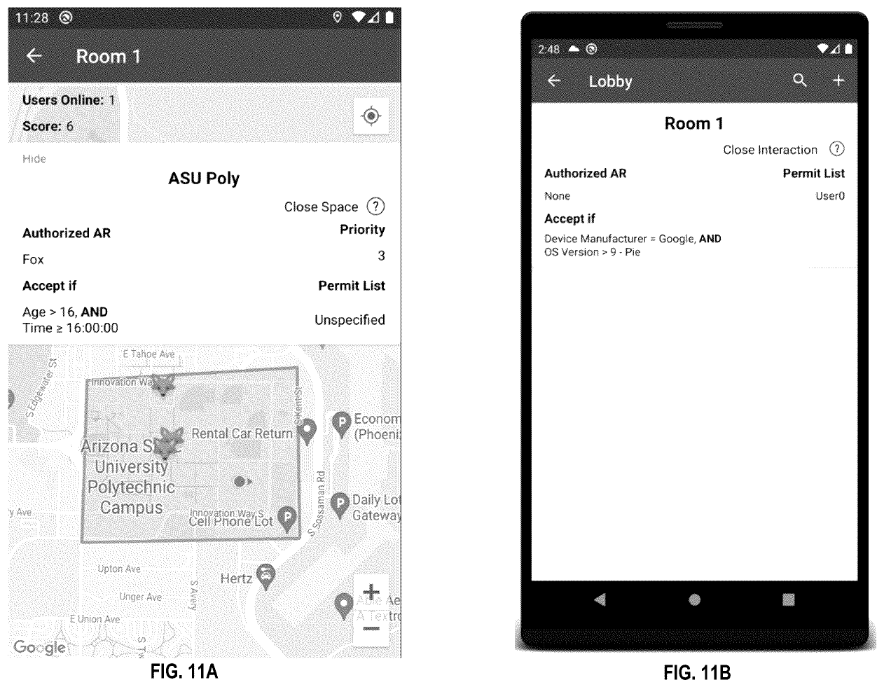

Phase 3: Questionnaire. To conclude a session, participants answered a questionnaire with relevant inquiries to reflect their understanding of the covered topics and provide feedback. This data was gathered through an online questionnaire divided into four sections, completed in an average of 15 minutes. The content used throughout the questionnaire is available upon request to the authors. The first section, scenario recognition, consisted of five scenarios with different security issues, and participants had to identify the undergoing attacks. Next, the policy-making section included two types of questions involving SpaceMediator's GUI. First, policy-making description through which participants associated a displayed policy, as FIG. 11A with its proper description, as shown in Table 4. Second, the policy-making attribute wallet consisted of selecting the attributes required to gain access over a stated policy, as FIG. 11B, while protecting their privacy. Subsequently, participants provided a scale representation, ranged 1 to 5, to reflect comprehension of the security topics throughout the policy understanding section. Finally, participants provided agreement on MAR-Apps regulations by the exit section.

Policy Evaluation. By following the English-written policy descriptions presented in Table 3 and using SpaceMediator, each participant created a total of four policies to regulate MAR and prevent space attacks. These policies had specific regulation goals stated in the descriptions, i.e., specifying the regulation type and applicable attributes. To evaluate if a policy was written correctly, the policy was evaluated against a request sequence that tested how authorization was handled over expected entities. For further clarity, consider the following example in which Exercise 1 states requirements to block three attributes (MAR spiders, user Eve, OS Pie) in the following way:
At the university campus, block “spiders” MAR content, and deny anyone with username “Eve” or anyone with an OS version less than Android Pie.

In SpaceMediator, users selected the regulation type for the policy, i.e., open or closed, and added relevant attributes. The side effects of the regulation type were adequately reflected on the GUI.

TABLE 5
Access Requests for Testing Exercise 1.

| Attribute | Request 1 | Request 2 | Request 3 |
|---|---|---|---|
| MAR Content | Spider | — | — |
| Username | — | Eve | Alice |
| OS Version | — | Android 10 | Oreo |

Nonetheless, participants could miswrite the policy, e.g., incorrect regulation type, missing relevant attributes, etc. Policies were assessed to determine whether it managed authorization properly by evaluating each policy against a sequence of requests containing essential details, as shown in Table 5 for Exercise 1. These policy-request evaluations were conducted through an automated process using the same API implemented in SpaceMediator and described in § 4. Furthermore, policy syntax was also manually reviewed to verify each request's Permit/Deny results. Finally, an evaluation scheme was followed to categorize a policy as: ideal (carried out all expected regulations); permissive (vulnerable to security problems); or restrictive (compromised functionality). For example, following Table 5, the ideal policy meets the standards by denying access to only three expected entities: spider, Eve, and Android Oreo; a permissive policy grants access to undesired parameters, i.e., Android Oreo; and a restrictive policy only allows limited attributes, i.e., Alice is given access but not Android.

6.2 Results

As previously described in § 6.1, participants were evenly distributed in terms of background field, CS vs. Non-CS. However, the population surveyed had distinct educational ranks since 22.50% recognized the high school as their highest level, 42.50% had concluded an undergraduate major, and 35.00% had achieved a graduate degree. Also, they identified different experience levels of familiarity with MAR as 65.0% had no prior knowledge, 32.5% held medium experience, and only 2.5% rated it as well known. As a result, with the study included a diverse population, gathered helpful information, and was further analyzed to answer various research questions.

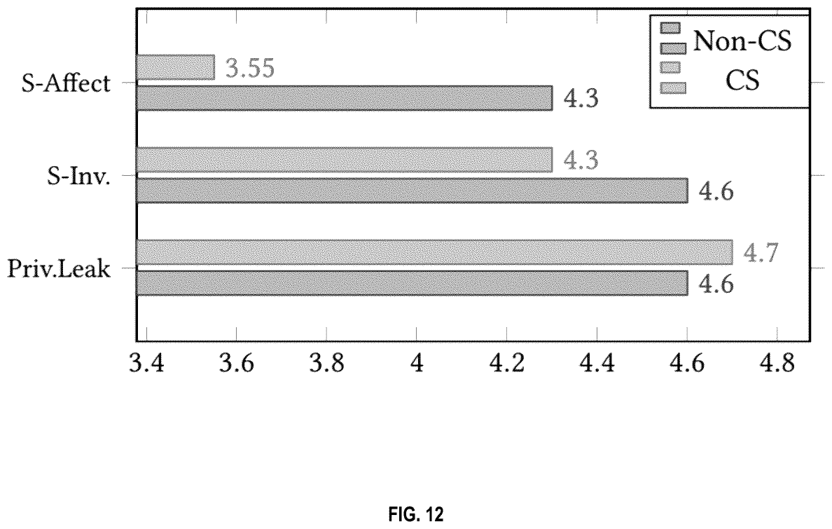

RQ1. Can participants understand the concepts of space invasion, space affectation, and privacy leak attacks? The questionnaire's policy understanding described in § 6.1 was performed to address RQ1. The results are shown in FIG. 12, with an average on each security issue per background field. Overall, participants successfully comprehended the issues described throughout the user study, as they provided good ratings reflecting it. However, space affectation had the lowest ranking with 3.55 within the CS participants, 4.30 among the Non-CS participants, and a prevailing norm of 3.93. On the other hand, space invasion had better ratings with 4.30 within the CS participants, 4.60 in the Non-CS participants, and an average of 4.45. Finally, privacy leak was the best-understood security issue with 4.70 for CS participants, 4.60 for Non-CS participants, and a standard of 4.65.

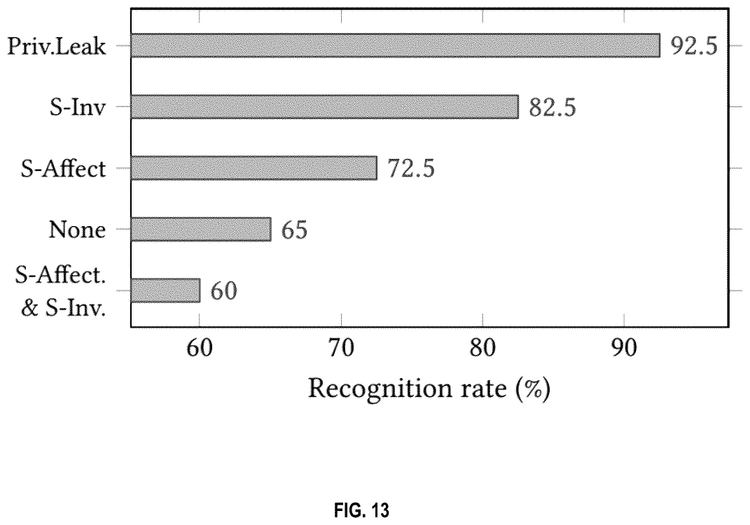

RQ2. Can participants identify security issues, with respect to the three attacks just mentioned? The questionnaire's scenario recognition was used to address RQ2. The outcomes are shown in FIG. 13. Privacy Leak was the most recognizable security issue, with 92.50% of participants identifying a such problem in the expected scenario. Afterward, space invasion had a distinction rate of 82.50%, followed by space affectation with 72.50%. Also, an uncompromised scenario with no undergoing attacks was identified by 65.00% of participants. Finally, with a 60.00% success rate, participants recognized simultaneous space invasion and space affectation attacks. Noticeably, the understandability reflected in RQ1 goes along with the identifiability success rates in RQ2. For example, privacy leak was the most understandable security issue by participants in RQ1, and at the same time, it had the highest identi-fiability success in RQ2. Furthermore, the exact trials apply to space invasion and space affectation in second and third places. Therefore, one can notice consistency over the user study data reflecting comprehension over security issues.

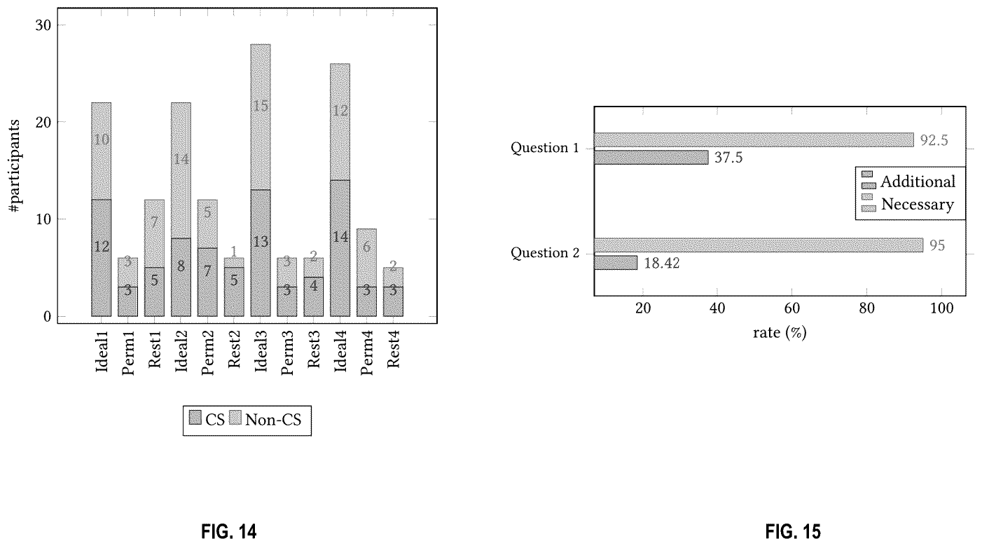

RQ3. Can participants write effective Space Protection Policies? Policies written by the participants acting as Space Owners throughout the MAR-App interaction were evaluated via a procedure described in § 6.1. The results are displayed in FIG. 14, with the results from Table's 3 Exercises 1-2. Overall, 55.00% of the policies were ideal as they effectively regulated a sensitive space, preventing a space invasion attack. The remaining set of improperly written policies contained different types of errors. For example, most of the incorrect policies for introductory Exercise 1 were restrictive at 30.00%, and the remaining 15.00% were permissive; on the other hand, the more challenging Exercise 2 had the opposite results with 30.00% permissive and 15.00% restrictive. It is noticeable that in Exercises 1 and 2, Non-CS participants had a higher success rate since at least 50.00% of them wrote ideal policies.

RQ4. Can participants write effective User Interaction Policies? The same procedure was followed for RQ4 as in RQ3. Therefore, results are also shown in FIG. 14, but with results from Table's 3 Exercises 3-4. Interestingly, the success rate of ideal policies was higher for user interaction, with 70.00% in introductory Exercise 3 and 65.00% in the more demanding Exercise 4. Although, there were still unsuccessful policies in terms of regulations. In Exercise 3, the mistaken policies had 15.00% for both permissive and restrictive; meanwhile, Exercise 4 had results of 22.50% permissive and 12.50% restrictive. The higher success rate on Exercises 3-4 may be related to increased familiarity with SpaceMediator. By the time participants reached these exercises, they had written the space protection policies from Exercises 1-2. Therefore, they likely had a better understanding of how to operate SpaceMediator, considering the importance of a step-by-step guide to ensure the GUI offered to write policies to regulate MAR-Apps is well understood. Although, more research is necessary to confirm this idea.

RQ5. Can participants understand the policies to counteract space attacks? The policy-making portion of the questionnaire was examined to address RQ5, described in § 6.1. In general, participants performed pretty well throughout these exercises. For example, the space regulation policy displayed in SpaceMediator GUI was associated with its appropriate description by 87.50% of the participants. In contrast, the user regulation policy had a lower success rate of 75.00%. Still, these are satisfactory results as they reflect comprehension by the majority of the population over the regulations implemented in a MAR-App. It is possible the long and complex description used through the questionnaire's policy-making confused participants. Therefore, breaking them into multiple easy-to-read questions could improve the outcomes. Of course, further research is necessary to understand the requirements for better results.

RQ6. Can participants utilize SpaceMediator's attribute wallet properly? The “attribute wallet” policy-making portion of the questionnaire was examined to address RQ6. The results are shown in FIG. 15. In the first question, which consisted of two details, i.e., username and SSN, 92.50% of the participants successfully selected necessary features for proper policy evaluation as one rule could be satisfied. Concurrently, 37.50% of them provided additional unnecessary information for the policy, e.g., date of birth, device manufacturer, OS version, etc. The results were similar throughout the second question in terms of access with 95.00%. Although, there was better awareness of privacy as only 18.42% of such participants supplied unneeded traits. Overall, a significant portion of participants provided only the necessary attributes. It is an excellent first step towards evaluating how an attribute wallet would respect users' privacy without compromising the functionality of MAR-Apps.

RQ7. Do participants agree with the regulation of MAR-Apps? The “exit” portion of the questionnaire described in § 6.1 was used to address RQ7. It was found that 87.50% of participants agreed that businesses and institutions should be able to regulate MAR-Apps, 7.50% were uncertain, and 5.00% were against it. Similarly, 82.50% of participants would regulate MAR-Apps if possible, 15.00% would consider it, and only 2.50% discarded it. Overall, there is high interest in the MAR-Apps regulation, preventing space invasion attacks and space affection.

### 7. Discussion and Future Work

The user study addressed the participants' understanding of the space and privacy attacks covered in § 3.2. As a result, it was found that a significant majority of the participants correctly comprehended the security issues. Furthermore, they successfully identified threats that compromised security on a given set of scenarios, as discussed in § 6.2. There was no noticeable difference in the performances between CS and Non-CS participants, indicating users can handle these issues without any specific background.

Upgrading the GUI. The usability of the proof-of-concept Policy-Governed MAR-App SpaceMediator was further addressed with the Control Model and implementation example covered in § 4. Overall, participants' performance was decent as most of their policies enforced ideal regulations. Nonetheless, there are areas for improvement in this field. For example, considering that Non-CS participants had a slightly better performance than CS, along with the high prevailing understandability of the security issues, better results on policy writing may depend on further development in SpaceMediator's front-end. As covered in § 5.3, SpaceMediator enabled users to write policies through a GUI that reflected applicable attributes and their effect on them, i.e., permit or deny. Therefore, the implementation example did seem to have an understandable GUI. However, this was not the top priority, and several participants missed the data pointed out, leading to erroneous policies. This shows the importance of MAR-Apps front-end when crafting regulations. For example, an MAR-app may benefit from a noticeable distinguishment between permit and deny, pointing out the relationship between attributes, building one rule at a time for better interpretation of policy structure, and vibration when updating policy's regulation type.

Need for Further Analysis. As a result, there might be a higher result on ideal policies. Furthermore, the policy evaluation types should be examined. As addressed in § 6.1, policy evaluation resulted in three categories: ideal, permissive, and restrictive. These evaluations enabled classification of the possible side effects that an erroneous approach could have while regulating a MAR-App. Although, the reality is that many participants had different errors within the same type. For example, permissive policies had security problems, but some only allowed one unauthorized entity while others had no restrictions. Therefore, through these evaluations, it is possible to know whether erroneous policies tend toward security or usability issues, but further analysis and development of policy classification is required to adequately assess the scalability of their consequences.

Ownership of Spaces. Participants were capable of specifying the sensitive spaces whenever writing a policy as a Space Owner, as explained in § 6.2. Still, there is a concern for further action to verify ownership over the claimed areas to prevent malicious entities from meanly regulating a space they do not legitimately own.

MAR-Apps have been problematic due to a lack of regulations since they are still in early development. However, as the MAR market is expected to grow at substantial rates, it is crucial to evaluate recorded issues to prevent further ones. The present disclosure introduced the concept of Policy-Governed MAR-Apps which protect sensitive spaces as only authorized MAR merges with the physical surroundings. At the same time, the Policy-Governed MAR-Apps allow benign multi-user interchange through controlled user interaction, and respect users' privacy by granting management over gathered sensitive information. One example Policy-Governed MAR-Apps is implemented as a proof-of-concept app “SpaceMediator” outlined herein. Additionally, the study showed a high interest throughout the user study community for further implementation of Policy-Governed MAR-Apps, along with high understandability over the risks MAR-Apps involve, and effective success rates in enforcing SpaceMediator's regulations. The present application shows that Policy-Governed MAR-Apps is a convenient regulatory mechanism to protect Space Owners and users.

### 8. Computer-implemented System

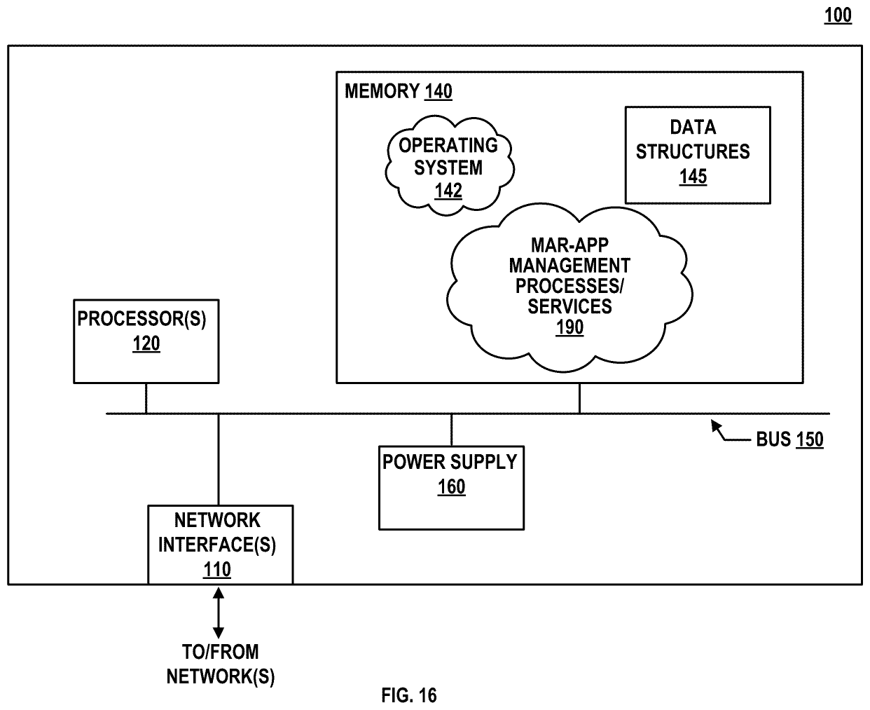

FIG. 16 is a schematic block diagram of an example implementation of the system 100 that may be used with one or more embodiments described herein, e.g., implementing the MAR-App Management Processes/Services 190 discussed herein with respect to FIGS. 2-3C.

System 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.).

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, system 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the MAR-App Management Processes/Services 190 and associated methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes system 100 by, inter alia, invoking operations in support of software processes and/or services executing on the device. These software processes and/or services may include MAR-App Management Processes/Services 190, which can include aspects various modules described herein. Note that while MAR-App Management Processes/Services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the MAR-App Management Processes/Services 190 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory, the memory including instructions accessible by the processor to:
access policy information regulating functionality of an MAR-App within a geographical boundary area;
access user attribute information associated with a user device, the user attribute information including values of one or more user attributes associated with the user device; and
preventing, based on the policy information and the user attribute information, operation of one or more services of the MAR-App at the user device when the user device is within the geographical boundary area.

2. The system of claim 1, the policy information including content regulation information detailing one or more regulations on content distributed through the MAR-App to be enforced within the geographical boundary area.

3. The system of claim 2, the content regulation information being associated with a room hosted in association with a provider device, the memory further including instructions executable by the processor to:
prevent, based on the content regulation information, operation of one or more services of the MAR-App with respect to the user device when the user device is within the geographical boundary area and when the user device is associated with the room of the MAR-App.

4. The system of claim 1, the policy information including user regulation information detailing one or more regulations on user access to MAR-app functionality to be enforced within the geographical boundary area.

5. The system of claim 4, the user regulation information being associated with a room hosted in association with a provider device, the memory further including instructions executable by the processor to:
prevent, based on the user regulation information and based on the one or more user attributes associated with the user device, access to the room by the user device.

6. The system of claim 1, the policy information including geographic information detailing the geographical boundary area.

7. The system of claim 1, the memory further including instructions executable by the processor to:
generate an access request for the user device requesting access to one or more services of the MAR-App at the user device, the access request including the user attribute information of the user device.

8. The system of claim 7, the memory further including instructions executable by the processor to:
request approval from the user associated with the user device for access to the user attribute information by a provider device.

9. The system of claim 7, the memory further including instructions executable by the processor to:
generate the access request for the user device requesting access to a room hosted in association with a provider device, the access request including the user attribute information of the user device and the room being associated with user regulation information that regulates user access to the room.

10. The system of claim 1, the memory further including instructions executable by the processor to:
receive, at a user interface, policy input from an entity for construction of the policy information regulating functionality of the MAR-App within the geographical boundary area,
construct the policy information regulating functionality of the MAR-App based on the policy input; and
store the policy information regulating functionality of the MAR-App at a data storage device in association with the processor.

11. The system of claim 1, the memory further including instructions executable by the processor to:
access a room generation input from an entity for generation of a room to be hosted in association with a provider device, where one or more functionalities of the MAR-App are accessible through the room;
construct the policy information regulating functionality of the MAR-App with respect to the room, the policy information including user regulation information and content regulation information associated with the room; and
facilitate communication between the provider device associated with the MAR-App and the user device in accordance with the policy information with respect to the room.

12. A method, comprising:
providing instructions within a memory executable by a processor to:
access policy information regulating functionality of an MAR-App within a geographical boundary area;
access user attribute information associated with a user device, the user attribute information including values of one or more user attributes associated with the user device; and
prevent, based on the policy information and the user attribute information, operation of one or more services of the MAR-App at the user device when the user device is within the geographical boundary area.

13. The method of claim 12, the policy information including content regulation information detailing one or more regulations on content distributed through the MAR-App to be enforced within the geographical boundary area.

14. The method of claim 13, the content regulation information being associated with a room hosted in association with a provider device, the method further comprising:
providing instructions within the memory executable by the processor to:
prevent, based on the content regulation information, operation of one or more services of the MAR-App with respect to the user device when the user device is within the geographical boundary area and when the user device is associated with the room of the MAR-App.

15. The method of claim 12, the policy information including user regulation information detailing one or more regulations on user access to MAR-app functionality to be enforced within the geographical boundary area.

16. The method of claim 15, the user regulation information being associated with a room hosted in association with a provider device, the method further comprising:
providing instructions within the memory executable by the processor to:
prevent, based on the user regulation information and based on the one or more user attributes associated with the user device, access to the room by the user device.

17. The method of claim 12, the method further comprising:
providing instructions within the memory executable by the processor to:
generate an access request for the user device requesting access to one or more services of the MAR-App at the user device, the access request including the user attribute information of the user device.

18. The method of claim 17, the method further comprising:
providing instructions within the memory executable by the processor to:
generate the access request for the user device requesting access to a room hosted in association with a provider device, the access request including the user attribute information of the user device and the room being associated with user regulation information that regulates user access to the room.

19. The method of claim 12, the method further comprising:
providing instructions within the memory executable by the processor to:
receive, at a user interface, policy input from an entity for construction of the policy information regulating functionality of the MAR-App within the geographical boundary area;
construct the policy information regulating functionality of the MAR-App based on the policy input; and
store the policy information regulating functionality of the MAR-App at a data storage device in association with the processor.

20. The method of claim 12, the method further comprising:
providing instructions within the memory executable by the processor to:
access a room generation input from an entity for generation of a room to be hosted in association with a provider device, where one or more functionalities of the MAR-App are accessible through the room;
construct the policy information regulating functionality of the MAR-App with respect to the room, the policy information including user regulation information and content regulation information associated with the room; and
facilitate communication between the provider device associated with the MAR-App and the user device in accordance with the policy information with respect to the room.
